(19) United States
(12) Patent Application Publication
(10) Pub. No.: US 2014/0320948 A1
(43) Pub. Date: Oct. 30, 2014

(54) OPTICAL ELEMENT AND IMAGE DISPLAY DEVICE

(71) Applicant: FUJIFILM CORPORATION, Tokyo (JP)

(72) Inventors: Hiroyuki SUZUKI, Shizuoka-ken (JP); Takashi KATO, Shizuoka-ken (JP)

(21) Appl. No.: 14/327,577

(22) Filed: Jul. 10, 2014

Related U.S. Application Data
(63) Continuation of application No. PCT/JP2013/058207, filed on Mar. 14, 2013.

(30) Foreign Application Priority Data
Mar. 30, 2012 (JP) 2012-082545

(51) Int. Cl. G02B 26/00

(52) U.S. Cl. CPC G02B 26/005
USPC 359/290

(57) ABSTRACT

An optical element (100) includes a cell (30) having: a first substrate (11), at least a portion of at least one surface of which has conductivity; a second substrate (12) which is arranged so as to face the conductive surface of the first substrate (11); a non-conductive oil (16) and a conductive hydrophilic liquid (14) that are provided between the conductive surface of the first substrate and the second substrate; and a hydrophobic insulating film (20) that is provided at least at a portion on the conductive surface side of the first substrate, that contacts the non-conductive oil, and that has a crosslinking structure derived from a polyfunctional compound having two or more polymerizable groups, wherein the shape of an interface between the non-conductive oil and the hydrophilic liquid changes according to the voltage applied between the hydrophilic liquid and the conductive surface (17A) of the first substrate.

### CROSS-REFERENCE TO RELATED APPLICATION

This application is a Continuation of PCT International Application No. PCT/JP2013/058207, filed Mar. 14, 2013, which claims priority under 35 U.S.C. §119(a) to Japanese Patent Application No. 2012-082545 filed Mar. 30, 2012. Each of the above applications is hereby expressly incorporated by reference, in its entirety, into the present application.

### BACKGROUND OF THE INVENTION

1. Technical Field

The present invention relates to an optical element and an image display device provided with the same.

2. Background Art

Conventionally, research has been conducted related to an optical element that is equipped with a cell including two or more kinds of liquid that do not mix each other (for example, oil and a hydrophilic liquid) and acts (drives) by application of voltage. Examples of such an optical element include an optical shutter, a variable focal length lens, an optical pickup lens, an image display device (including a 3D image display device), a signage, an optical modulator, and a pump system.

In recent years, an optical element utilizing the electrowetting phenomenon has attracted particular attention as the kind of optical element described above.

As an optical element utilizing the electrowetting phenomenon, for example, an electrowetting display (image display device) is known that includes: a first substrate and a second substrate which face each other; plural projections which are arranged at the facing side of the second substrate in a lattice structure to define plural pixel units; a non-conductive first fluid which is sealed in a pixel unit between two adjacent projections; and a second fluid which is sealed between the first fluid and the first substrate and is a conductive or polar liquid immiscible with the first fluid, in which the pixel unit is configured to include a common signal line, a storage capacity, and a thin-film transistor, which are provided in a prescribed arrangement (see, for example, Japanese Patent Application Laid-Open (JP-A) No. 2009-86668).

Further, a display element is known that performs switching of displays by means of changing the amount of light that passes through a mask, in which the display element has a first support and a second support, and a first liquid and a conductive or polar second liquid which are immiscible with each other and are sealed in a space formed between the first support and the second support, and the amount of light that passes through the mask is regulated by application of voltage to the second liquid, thereby changing the shape of an interface between the first liquid and the second liquid (see, for example, JP-A No. 2000-356750).

Moreover, a display device is known that includes: a first base material that constitutes the lowermost layer of the display device; a first electrode provided on the first base material; an insulating layer provided on the first electrode; a second electrode provided on the insulating layer; a cavity partition that surrounds the second electrode at specific intervals; a second base material which is provided on the cavity partition and constitutes the uppermost layer; and a colored liquid droplet sealed within the cavity partition, in which the display device further has a third electrode for encouraging the colored liquid droplet to return to a spherical shape (see, for example, JP-A No. 2004-252444).

Further, as an optical element utilizing the electrowetting phenomenon, a variable focal length lens is also known, which includes a chamber filled with a first liquid having conductivity; a liquid droplet of a second liquid having an insulating property, the liquid droplet being arranged on the contact region at a first surface of an insulating wall of the chamber, being not miscible with the first liquid, and having a refractive index different from that of the first liquid and a density substantially the same as that of the first liquid; a voltage supply which is configured so as to apply a voltage between the first liquid and an electrode that is arranged on a second surface of the insulating wall; and an alignment means for maintaining the alignment at the edge portion of the liquid droplet and controlling the shape thereof during the application of a voltage (see, for example, Japanese National Phase Publication No. 2001-519539).

### SUMMARY OF THE INVENTION

According to an aspect of the invention, an optical element (100) exhibiting suppressed deterioration of the hydrophobic insulating film when the voltage is repeatedly switched on and off, which includes a cell (30) having a first substrate (11), at least a portion of at least one surface of which has conductivity, a second substrate (12) which is arranged so as to face the conductive surface of the first substrate (11), a non-conductive oil (16) and a conductive hydrophilic liquid (14) which are provided between the conductive surface of the first substrate (11) and the second substrate (12), and a hydrophobic insulating film (20) which is provided at least at a portion on the conductive surface side of the first substrate (11), contacts the non-conductive oil (16), and has a crosslinking structure derived from a polyfunctional compound having two or more polymerizable groups, in which the shape of an interface between the non-conductive oil (16) and the hydrophilic liquid (14) changes according to the voltage applied between the hydrophilic liquid (14) and the conductive surface (17A) of the first substrate; and an image display device formed therewith exhibiting excellent durability during repeated driving, are provided.

### Technical Problem

Incidentally, in an optical element which is equipped with a cell containing two or more kinds of liquids that do not mix with each other (for example, oil and a hydrophilic liquid), a hydrophobic insulating film which is in contact with the oil is disposed at the inner face of the cell, and voltage is applied between the hydrophilic liquid and the inner face of the cell sandwiching the hydrophobic insulating film. Hereby, charge is generated at the surface of the hydrophobic insulating film, and the shape of an interface between the oil and the hydrophilic liquid changes due to this charge, whereby the optical element is driven.

However, in such an optical element, there are cases in which the hydrophobic insulating film deteriorates when driving (application of a voltage) is performed repeatedly. In connection with this problem, since a linear fluoropolymer that does not have a crosslinking structure is only used in the hydrophobic insulating films of the optical elements described in JP-A Nos. 2009-86668, 2000-356750, and 2004-252444, and Japanese National Phase Publication No. 2001-519539, the hydrophobic insulating film readily deteriorates when driving (application of a voltage) is performed repeatedly and, as a result, there are cases in which the optical element lacks durability.

The present invention has been made in view of the above problems and aims to accomplish the following. Namely, an aspect of the invention is to provide an optical element in which deterioration of a hydrophobic insulating film during repeated driving is suppressed and which has excellent durability, and an image display device.

### Solution to Problem

Specific means to achieve the above objects are as follows.

<1> An optical element including a cell, the cell including; a first substrate, at least a portion of at least one surface of which has conductivity; a second substrate which is arranged so as to face the conductive surface of the first substrate; a non-conductive oil and a conductive hydrophilic liquid that are provided between the conductive surface of the first substrate and the second substrate; and a hydrophobic insulating film that is provided at least at a portion on the conductive surface side of the first substrate, that contacts the non-conductive oil, and that has a crosslinking structure derived from a polyfunctional compound having two or more polymerizable groups, wherein a shape of an interface between the non-conductive oil and the hydrophilic liquid changes according to a voltage applied between the hydrophilic liquid and the conductive surface of the first substrate.

<2> The optical element according to the item <1>, wherein a contact area between the non-conductive oil and the hydrophobic insulating film changes according to the voltage.

<3> The optical element according to the item <1> or <2>, wherein the polyfunctional compound is a fluorine-containing compound.

<4> The optical element according to any one of the items <1> to <3>, wherein the polyfunctional compound is a fluorine-containing compound, in which the fluorine content is 30% by mass or higher based on molecular weight.

<5> The optical element according to any one of the items <1> to <4>, wherein the polyfunctional compound has three or more polymerizable groups.

<6> The optical element according to any one of the items <1> to <5>, wherein the hydrophobic insulating film has been prepared by curing a curable composition containing the polyfunctional compound, and has a crosslinking structure formed by polymerization of the polyfunctional compound.

<7> The optical element according to any one of the items <1> to <6>, wherein the polyfunctional compound is represented by the following Formula (A):

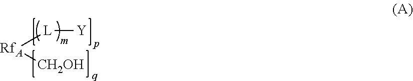

In Formula (A), Rf_{A} represents a (p+q)-valent linear or cyclic linking group containing a carbon atom and a fluorine atom. In Formula (A), p represents an integer of 3 to 10; q represents an integer of 0 to 7; and (p+q) is an integer of 3 to 10. In Formula (A), m represents 0 or 1. In Formula (A), L represents a divalent linking group of an alkylene group having from 1 to 10 carbon atoms, an arylene group having from 6 to 10 carbon atoms, —O—, —S—, —N(R)—, or a group obtained by a combination of an alkylene group having from 1 to 10 carbon atoms and at least one of —O—, —S—, or —N(R)—; R represents a hydrogen atom or an alkyl group having from 1 to 5 carbon atoms. In Formula (A), Y represents a polymerizable group selected from the group consisting of a (meth)acryloyl group, an allyl group, an alkoxysilyl group, an α-fluoroacryloyl group, an epoxy group and —C(O)OCH═CH₂.

<8> The optical element according to any one of the items <1> to <7>, wherein the polyfunctional compound is represented by the following Formula (B):

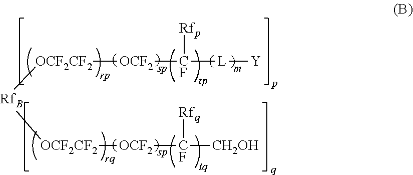

In Formula (B), Rf_{B} represents a (p+q)-valent linear or cyclic saturated perfluorohydrocarbon group or a (p+q)-valent linear or cyclic linking group obtained by a combination of a saturated perfluorohydrocarbon group and —O—. In Formula (B), each of Rfₚ and Rf_{q} independently represents a monovalent linear or cyclic group containing a carbon atom and a fluorine atom. In Formula (B), p represents an integer of 3 to 10; q represents an integer of 0 to 7; and (p+q) is an integer of 3 to 10. In Formula (B), m represents 0 or 1. In Formula (B), each of rp and rq independently represents an integer of 0 to 100; each of sp and sq independently represents 0 or 1; each of tp and tq independently represents 0 or 1. In Formula (B), L represents a divalent linking group of an alkylene group having from 1 to 10 carbon atoms, an arylene group having from 6 to 10 carbon atoms, —O—, —S—, —N(R)—, or a group obtained by a combination of an alkylene group having from 1 to 10 carbon atoms and at least one of —O—, —S—, or —N(R)—; R represents a hydrogen atom or an alkyl group having from 1 to 5 carbon atoms. In Formula (B), Y represents a polymerizable group selected from the group consisting of a (meth)acryloyl group, an allyl group, an alkoxysilyl group, an α-fluoroacryloyl group, an epoxy group and —C(O)OCH═CH₂.

<9> The optical element according to any one of the items <1> to <8>, wherein the polyfunctional compound is represented by the following Formula (1):

RfLₘY]ₙ (1)

In Formula (1), Rf represents an n-valent group selected from the group consisting of the following Formulae (f-1) to (f-9); L represents a divalent linking group of an alkylene group having from 1 to 10 carbon atoms, an arylene group having from 6 to 10 carbon atoms, —O—, —S—, —N(R)—, or a group obtained by a combination of an alkylene group having from 1 to 10 carbon atoms and at least one of —O—, —S—, or —N(R)—; R represents a hydrogen atom or an alkyl group having from 1 to 5 carbon atoms; Y represents a polymerizable group selected from the group consisting of a (meth)acryloyl group, an allyl group, an alkoxysilyl group, an α-fluoroacryloyl group, an epoxy group and —C(O)OCH═CH₂; n represents an integer of 3 to 6; and m represents 0 or 1. In Formulae (f-1) to (f-9), in a case in which m represents 1, * represents a bonding site to bond to L; and in a case in which m represents 0, * represents a bonding site to bond to Y:

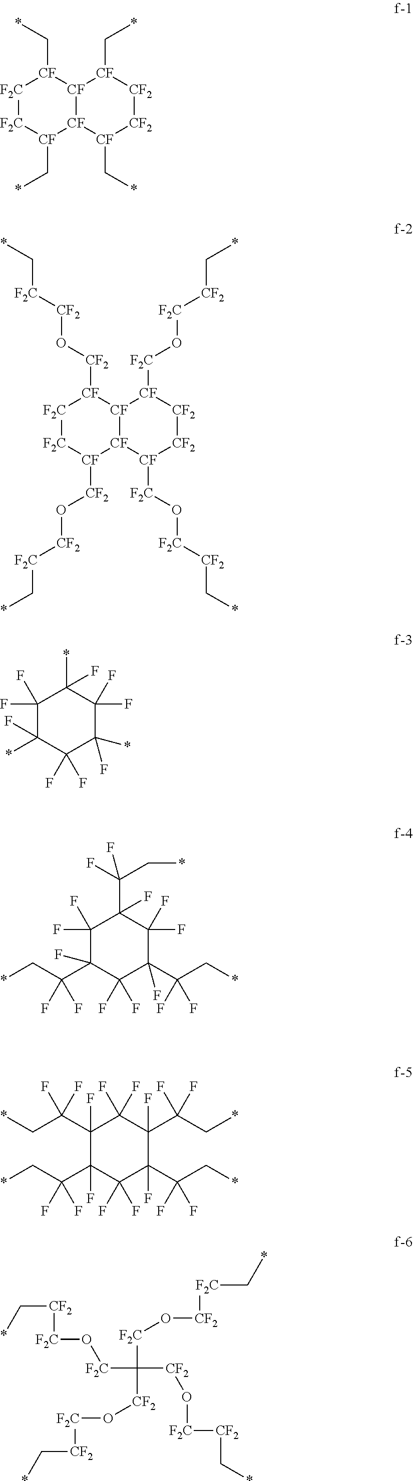

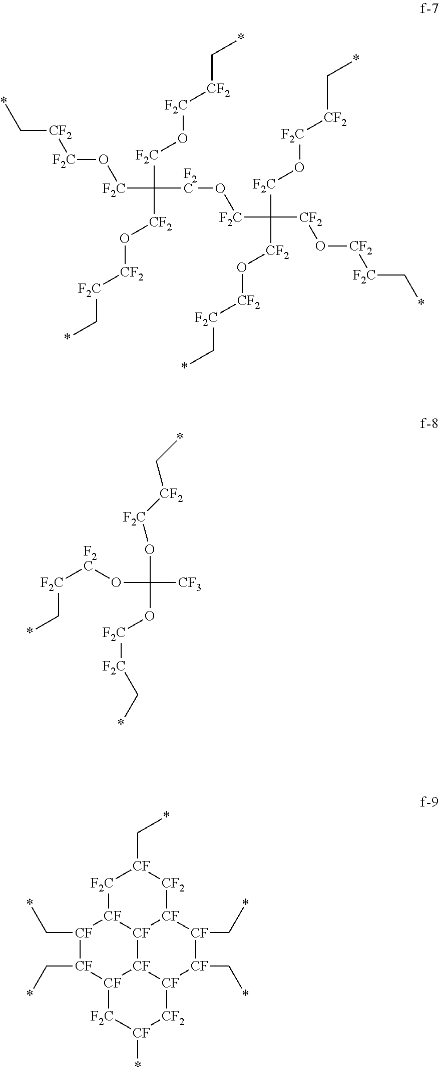

<10> The optical element according to any one of the items <1> to <9>, wherein the polyfunctional compound is a fluorine-containing compound, in which all calculated values for molecular weight between crosslinkings are respectively 300 or less, when polymerization is performed using the two or more polymerizable groups to form a crosslinking structure.

<11> The optical element according to any one of the items <1> to <10>, wherein the polyfunctional compound is represented by any one of the following Formulae (M-1) to (M-13):

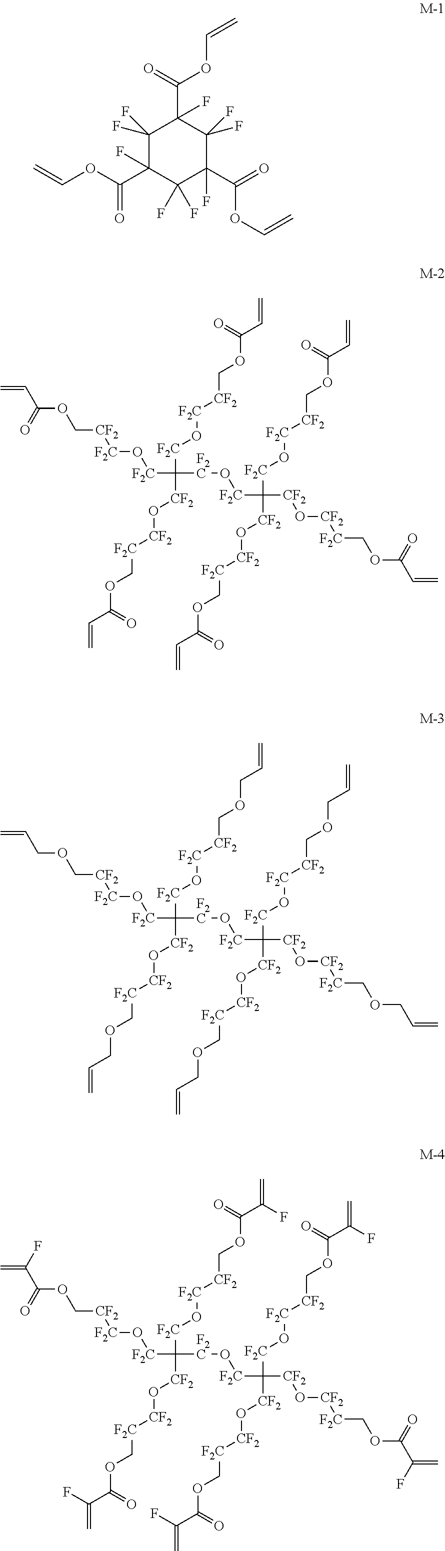

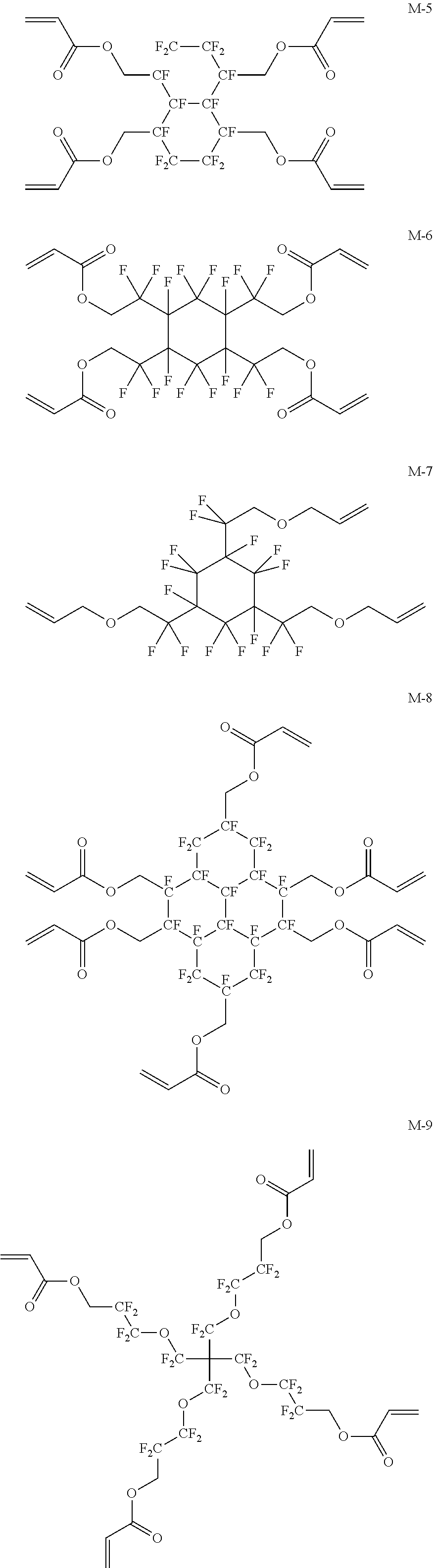

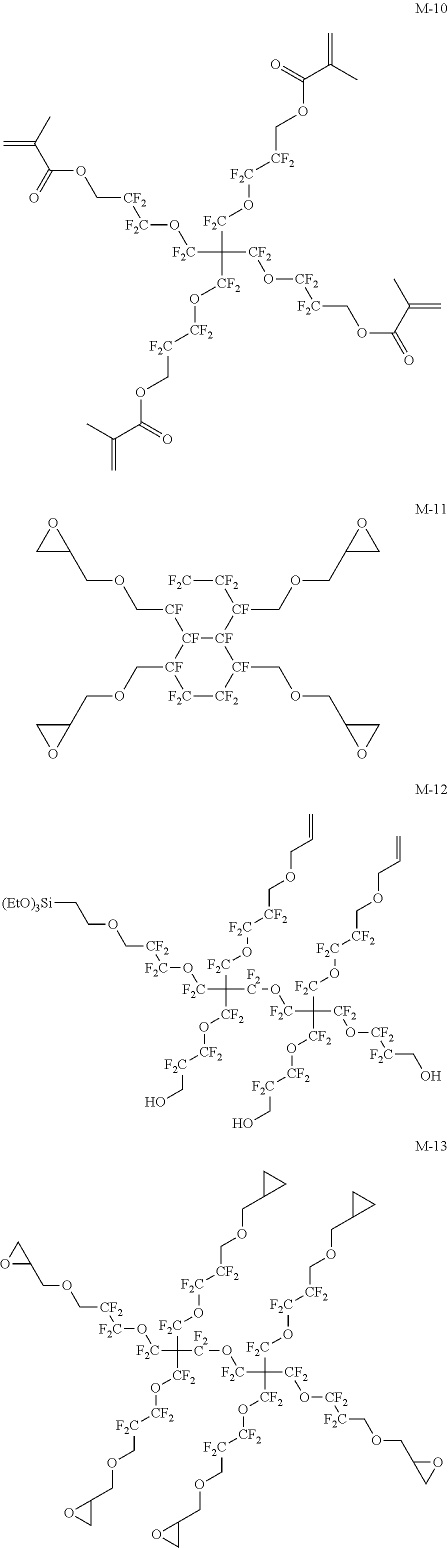

<12> The optical element according to any one of the items <1> to <11>, wherein the first substrate includes a conductive film, and the conductive surface of the first substrate is a surface of the conductive film.

<13> The optical element according to any one of the items <1> to <12>, wherein at least one of the first substrate or the second substrate has light transmittance of 80% or higher over the entire wavelength region of from 380 nm to 770 nm.

<14> The optical element according to any one of the items <1> to <13>, wherein a viscosity of the non-conductive oil is in a range of from 0.01 mPa·s to 8 mPa·s, and the conductive hydrophilic liquid includes an aqueous solvent and an electrolyte in a concentration range of from 0.1 mol/L to 10 mol/L.

<15> An image display device provided with a pixel comprising the optical element according to any one of the items <1> to <14>, wherein the non-conductive oil includes a coloring material.

### Effects of Invention

According to the present invention, an optical element, in which deterioration of a hydrophobic insulating film during repeated driving is suppressed and which exhibits excellent durability, and an image display device may be provided.

### BRIEF DESCRIPTION OF DRAWINGS

FIG. 1 is a schematic sectional view conceptually illustrating a first exemplary embodiment (voltage off state) of the optical element of the present invention.

FIG. 2 is a schematic sectional view conceptually illustrating a first exemplary embodiment (voltage on state) of the optical element of the present invention.

FIG. 3 is a schematic sectional view conceptually illustrating a second exemplary embodiment (voltage off state and voltage on state) of the optical element of the present invention.

FIG. 4 is a schematic sectional view conceptually illustrating a test cell used in the example.

### DESCRIPTION OF EMBODIMENTS

Hereinafter, the optical element and image display device of the present invention are described in detail.

<<Optical Element>>

The optical element of the present invention is equipped with a cell having a first substrate, at least a portion of at least one surface of which has conductivity, a second substrate which is arranged so as to face the conductive surface of the first substrate, a non-conductive oil and a conductive hydrophilic liquid which are provided between the conductive surface of the first substrate and the second substrate, and a hydrophobic insulating film which is provided at least at a portion on the conductive surface side of the first substrate, contacts with the oil, and has a crosslinking structure derived from a polyfunctional compound having two or more polymerizable groups, wherein the shape of an interface between the oil and the hydrophilic liquid changes according to the voltage applied between the hydrophilic liquid and the conductive surface of the first substrate.

In the optical element of the present invention, a voltage is applied between the conductive hydrophilic liquid and the conductive surface of the first substrate (namely, through the hydrophobic insulating film). When the voltage applied exceeds the prescribed threshold value, a charge is generated at the surface of the hydrophobic insulating film. Due to this charge, the conductive hydrophilic liquid approaches to the hydrophobic insulating film (more preferably, the conductive hydrophilic liquid pushes the oil that has been in contact with the hydrophobic insulating film, and contacts with the hydrophobic insulating film), and thus, the shape of an interface between the oil and the hydrophilic liquid is altered, whereby the optical element acts (drives).

Among conventional optical elements, there are optical elements that drive in a manner as described above.

However, it becomes clear that, in the conventional optical elements, when driving (application of a voltage) is repeatedly performed, and generation and extinction of charge in the surface of the hydrophobic insulating film are repeated, the hydrophobic insulating film deteriorates and, as a result, there are cases in which the responsiveness of the optical element is deteriorated.

In connection to this respect, in the optical element of the present invention, the hydrophobic insulating film is constituted to have a crosslinking structure derived from a polyfunctional compound having two or more polymerizable groups, and thus, the film strength of the hydrophobic insulating film is higher. Therefore, the deterioration of the hydrophobic insulating film when application of a voltage is repeatedly performed is suppressed.

Thus, according to the present invention, the deterioration of the hydrophobic insulating film during repeated driving is suppressed, and the durability of the optical element is improved.

Particularly, in a case in which the contact area between the oil and the hydrophobic insulating film is altered by the application of a voltage (when the hydrophilic liquid pushes the oil that has been in contact with the hydrophobic insulating film, so that the conductive hydrophilic liquid is brought into contact with the hydrophobic insulating film), the deterioration of the hydrophobic insulating film during repeated driving is remarkable. The reason for this is thought as follows. Namely, in a case in which the contact area changes (namely, in a case in which the boundary among three substances, i.e., the oil, the hydrophobic insulating film, and the hydrophilic liquid, moves), the hydrophilic liquid easily swells the hydrophobic insulating film, and the surface of the hydrophobic insulating film easily produces friction due to the movement of the boundary.

Accordingly, in a case in which the contact area between the oil and the hydrophobic insulating film changes, the effect on suppression of deterioration of the hydrophobic insulating film by the crosslinking structure is further remarkably realized.

In the present invention, in order to alter the interface shape (preferably, the contact area), although the voltage (drive voltage) to be applied between the hydrophilic liquid and the conductive surface of the first substrate is not particularly limited, the voltage to be supplied can be arbitrarily set, for example, to a value in a range of from 1 V to 25 V (preferably, from 1 V to 20 V).

Further, the drive voltage may be a direct voltage or may be an alternating voltage.

The use of the optical element of the present invention is not particularly limited as long as the optical element has the above configuration.

For example, the optical element of the present invention can be preferably applied to, for example, optical shutters described in JP-A No. 2000-356792 and the like; variable focal length lenses described in JP-A No. 2001-013306, Japanese National Phase Publication No. 2001-519539, JP-A No. 2008-96953, and the like; optical pickup lenses described in Japanese National Phase Publication No. 2007-530997; displays or signages described in JP-A Nos. 2009-86668 and 10-39800, Japanese National Phase Publication Nos. 2005-517993 and 2007-531917, JP-A Nos. 2004-252444 and 2004-287008, and the like; 3D displays described in Japanese National Phase Publication No. 2005-506778 and the like; optical modulators described in JP-A No. 2010-79297 and the like; or pump systems described in U.S. Patent No. 2011/0083964 and the like.

The optical element of the present invention is preferably an electowetting element that acts by the electrowetting phenomenon. The electrowetting phenomenon is known, and the details thereof are as described in the above official reports.

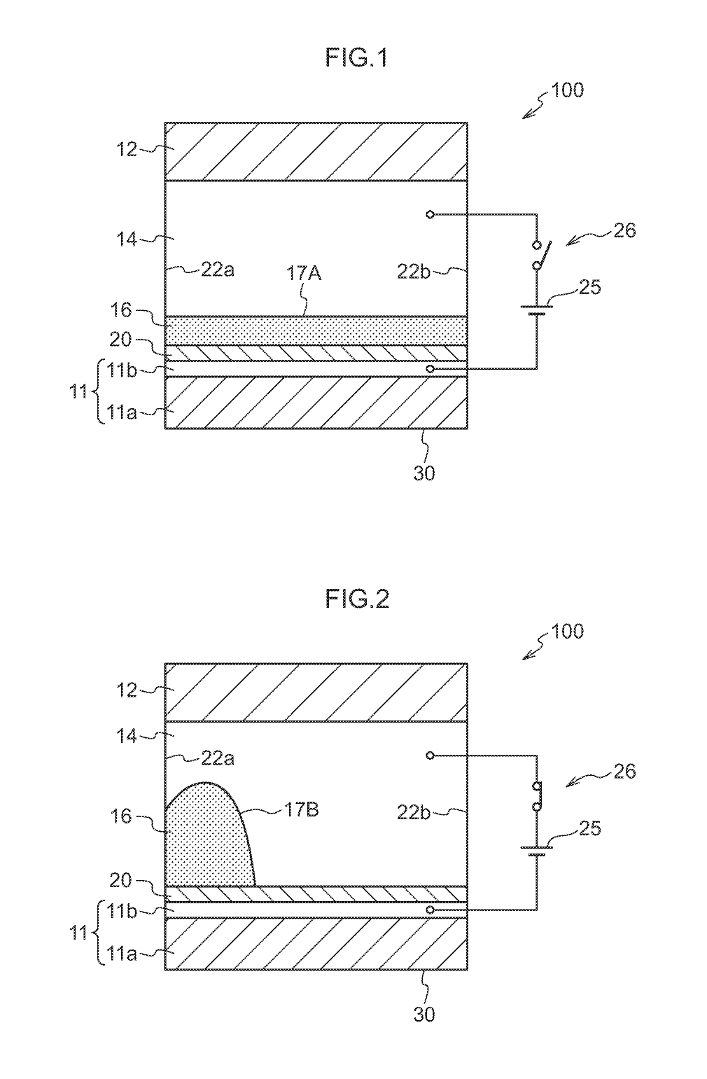

Hereinafter, exemplary embodiments of the optical element of the present invention are described in detail with reference to FIG. 1 to FIG. 3, but it should be construed that the present invention is not limited to the following exemplary embodiments.

### First Exemplary Embodiment

FIG. 1 and FIG. 2 are schematic sectional views conceptually illustrating a first exemplary embodiment of the optical element of the present invention. This first exemplary embodiment is an exemplary embodiment that is preferable in the case of using the optical element of the present invention as a pixel of an image display device.

FIG. 1 shows the voltage off state (the state where a voltage is not applied; hereinafter, the same applies.) of an optical element 100, and FIG. 2 shows the voltage on state (the state where a voltage is applied; hereinafter, the same applies.) of the same optical element 100.

As shown in FIG. 1 and FIG. 2, the optical element 100 is constituted to have a cell 30 provided with a hydrophilic liquid 14 and oil 16 in a region which is between a hydrophobic insulating film 20 provided on a substrate 11 (a first substrate) and a substrate 12 (a second substrate) and is divided by a side face 22a and a side face 22b.

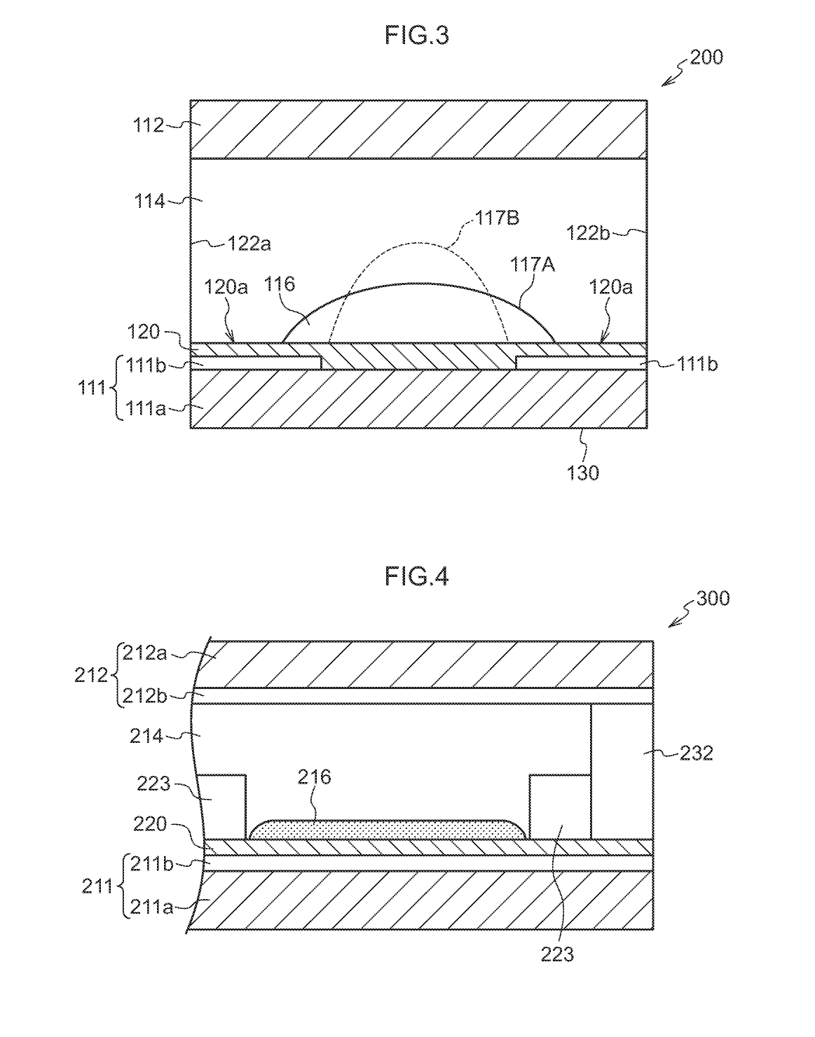

Here, the side face 22a and the side face 22b are each configured, for example, as a side face of a partition. In FIG. 1 and FIG. 2, a closed space is formed by the hydrophobic insulating film 20, the substrate 12, the side face 22a, and the side face 22b; however, the present invention is not limited to this form. For example, a portion of the side face 22a and the side face 22a (preferably, a portion on the side of the substrate 12) may be opened (the same applies to the side face 122a and the side face 122b in FIG. 3 described below.).

The substrate 11 is constituted of a substrate 11a and a conductive film 11b provided on the substrate 11a. This conductive film 11b functions as one of the electrodes for applying a voltage between the conductive film 11b and the hydrophilic liquid 14.

In the optical element 100, the hydrophobic insulating film 20 is provided so as to be in contact with this conductive film 11b. This hydrophobic insulating film 20 has a crosslinking structure derived from a polyfunctional compound having two or more polymerizable groups.

The hydrophilic liquid 14 and the oil 16 are liquids which do not mix with each other, and are separated from each other by an interface 17A or an interface 17B.

In FIG. 1 and FIG. 2, the interface between the hydrophilic liquid 14 and the oil 16 in the voltage off state is denoted as the interface 17A (FIG. 1), and the interface between the hydrophilic liquid 14 and the oil 16 in the voltage on state is denoted as the interface 17B (FIG. 2).

Further, in this optical element 100, an electric power supply 25 (a voltage application means) for applying a voltage between the conductive film 11b and the hydrophilic liquid 14, and a switch 26 for turning on/off this voltage are provided.

In this exemplary embodiment, the application of a voltage (potential) to the hydrophilic liquid 14 is carried out by using an electrode which is inserted in the hydrophilic liquid 14. However, the present invention is not limited to this form. The optical element may have a configuration in which a surface of the substrate 12, the surface being on the side that contacts with the hydrophilic liquid 14, has conductivity (for example, a configuration in which a conductive film exists on the side of the substrate 12, the side contacting with the hydrophilic liquid 14), and the application of a voltage (potential) to the hydrophilic liquid 14 may be carried out by applying a voltage (potential) to this conductive surface (for example, to the conductive film).

Next, the actions of the optical element 100 (the voltage off state and the voltage on state) are described.

As shown in FIG. 1, in the voltage off state, since the affinity between the hydrophobic insulating film 20 and the oil 16 is high, the oil 16 is in a state of being in contact with the entire surface of the hydrophobic insulating film 20.

When a voltage is applied to the optical element 100, the interface between the hydrophilic liquid 14 and the oil 16 transforms, such as from the interface 17A (FIG. 1) to the interface 17B (FIG. 2), and thus, the contact area between the hydrophobic insulating film 20 and the oil 16 is reduced, and the oil 16 moves to the edge of the cell. As described above, this phenomenon is a phenomenon which is caused when a charge is generated at the surface of the hydrophobic insulating film 20 by the application of a voltage, and due to this charge, the hydrophilic liquid 14 pushes the oil 16 that has been in contact with the hydrophobic insulating film 20, to be in contact with the hydrophobic insulating film 20.

When the voltage in FIG. 2 is let be in the off state, the state of the optical element 100 returns again to the state of FIG. 1.

In the optical element 100, the actions shown in FIG. 1 and FIG. 2 are performed repeatedly; however, since the hydrophobic insulating film 20 has a crosslinking structure derived from a polyfunctional compound having two or more polymerizable groups, the deterioration of the hydrophobic insulating film 20 during repeated actions is suppressed.

In the above description, the first exemplary embodiment of the optical element of the present invention is explained with reference to FIG. 1 and FIG. 2; however, the present invention is not limited to this exemplary embodiment.

For example, in FIG. 1 and FIG. 2, the conductive film 11b is provided over the entire surface of the substrate 11; however, a form in which the conductive film is provided only on a portion of the surface of the substrate may also be employed.

Further, as described above, in addition to the existence of the conductive film 11b on the substrate 11, a conductive film may also exist on the side of the substrate 12, contacting with the hydrophilic liquid 14.

In the above exemplary embodiment, by adding at least one coloring material to the oil 16, to color the oil 16 to have a desired color (for example, black, red, green, blue, cyan, magenta, yellow, or the like), the optical element 100 can be used as one pixel of an electrowetting image display device (hereinafter, may also referred to as, simply, “image display device”). In this case, the oil 16 functions, for example, as an optical shutter that changes the on state and off state of the pixel. The details of the function are as described in, for example, the above-described official reports. In this case, the image display device may be an image display device of any system of a transmission type, a reflection type, or a semi-transmission type.

In the case of using the optical element 100 as one pixel of an image display device, the surface of the substrate may be divided by a partition, for example, in a lattice-like shape, and one region that has been divided can let be one pixel. In this process, the conductive film 11b may be a film that is patterned independently for every one pixel (for example, in the case of an active matrix type image display device or the like), or may be a film that is patterned in a striped shape lying across plural pixels (for example, in the case of a passive matrix type image display device or the like).

Further, in the case of using the optical element 100 as one pixel of an image display device, a portion of the side faces 22a and 22b on the substrate 12 side may be opened, so that the space between the hydrophobic insulating film 20 and the substrate 12 (the second substrate) may be communicated over plural pixels.

Moreover, in the case of using the optical element 100 as one pixel of an image display device, by using a substrate having light transmitting property such as glass or plastic (polyethylene terephthalate, polyethylene naphthalate, or the like) as the substrate 11a and the substrate 12, and also using a film having light transmitting property as the conductive film 11b and the hydrophobic insulating film 20, a pixel of a transmission type image display device can be prepared. In this pixel of a transmission type image display device, by providing a reflective plate at the outside of the cell, a pixel of a reflection type image display device can also be prepared.

Further, by using, as the conductive film 11b, a film having an additional function as a reflective plate (for example, a metal film such as an Al film or an Al alloy film), or using, as the substrate 11a, a substrate having an additional function as a reflective plate (for example, a metal substrate such as an Al substrate or an Al alloy substrate), a pixel of a reflection type image display device can also be prepared.

In the case of using the optical element 100 in the present exemplary embodiment as one pixel of an image display device, the other configuration of the cell or the image display device may be a known configuration described in, for example, JP-A No. 10-39800, Japanese National Phase Publication No. 2005-517993, JP-A Nos. 2004-252444 and 2004-287008, Japanese National Phase Publication Nos. 2005-506778 and 2007-531917, JP-A No. 2009-86668, and the like. Further, the configuration of a known active matrix type or passive matrix type liquid crystal display device can also be referred to.

### Second Exemplary Embodiment

FIG. 3 is a schematic sectional view conceptually illustrating a second exemplary embodiment of the optical element of the present invention.

This second exemplary embodiment is an exemplary embodiment that is preferable in the case of using the optical element of the present invention as a variable focal length lens.

As shown in FIG. 3, the optical element 200 has, similar to the optical element 100 described above, a cell 130 provided with a hydrophilic liquid 114 and oil 116 in a region which is between a hydrophobic insulating film 120 provided on a substrate 111 (a first substrate) and a substrate 112 (a second substrate) and is divided by a side face 122a and a side face 122b. Although the illustration is omitted in FIG. 3, an electric power supply and a switch are connected to the optical element 200, similar to the optical element 100.

The configuration of the optical element 200 is substantially similar to the configuration of the optical element 100, except the following respects.

Namely, in the surface of the hydrophobic insulating film 120, the periphery 120a excluding the center portion (preferably, a circular region) is subjected to a hydrophilic treatment. According to this, the oil 116 contacts only with the center portion (preferably, a circular region) of the surface of the hydrophobic insulating film 120, and therefore, in the voltage off state, the interface 117A between the oil 116 and the hydrophilic liquid 114 is in the state of a curved face.

Further, the substrate 111 (the first substrate) is constituted to have a substrate 111a and a conductive film 111b that has been subjected to patterning such that the center portion (preferably, a circular region) of the surface of the substrate 111a is exposed. Here, when the optical element is observed from the direction perpendicular to the surface of the substrate 111a, the conductive film 111b is patterned such that the pattern edge is positioned inside the contact region between the oil 116 and the hydrophobic insulating film 120 in the voltage off state.

In the optical element 200, the substrate 111, the hydrophobic insulating film 120, the oil 116, the hydrophilic liquid 114, and the substrate 112 have light transmitting property.

Thus, the oil 116 functions as a lens.

In FIG. 3, the interface between the oil 116 and the hydrophilic liquid 114 in the voltage off state is denoted as the interface 117A, and the interface between the oil 116 and the hydrophilic liquid 114 in the voltage on state is denoted as the interface 117B.

As shown in FIG. 3, the interface between the oil 116 and the hydrophilic liquid 114 in the voltage off state already has a specified curvature (the interface 117A); however, in the voltage on state, the curvature of the interface becomes greater (the interface 117B). The reason for this is because a charge is generated at the surface (the contact face with the oil 116) of the hydrophobic insulating film 120, similar to the case of the first exemplary embodiment, when a voltage is applied.

In such a manner, by the application of a voltage, the curvature of the interface between the oil 116 and the hydrophilic liquid 114 can be altered, and thus, the focal length of a lens formed from the oil 116 can be altered.

Also in the optical element 200, when the voltage is repeatedly switched on and off, generation and extinction of charge are repeated at the surface of the hydrophobic insulating film 120.

Also in this case, since the hydrophobic insulating film 120 has a crosslinking structure which is derived from a polyfunctional compound having two or more polymerizable groups, the deterioration of the hydrophobic insulating film 120 during repeated driving is suppressed.

The optical element 200 is merely an example of the case of using the oil 116 as a variable focal length lens, and it is possible to make various changes to the configuration thereof. For example, when the form is changed to a form in which the periphery 120a is not subjected to a hydrophilic treatment, and thus, the oil 116 is brought into contact with the entire surface of the hydrophobic insulating film 120, and a conductive film and a hydrophobic insulating film are also provided on the side faces 122a and 122b, only the shape (the focal length of the lens) of the interface between the hydrophilic liquid 114 and the oil 116 can be changed, without changing the contact area between the hydrophobic insulating film 120 and the oil 116.

For the specific examples of the configuration of an optical element in the case of using the optical element as a variable focal length lens, known configurations described in, for example, Japanese Patent No. 4154858, JP-A No. 2001-013306, Japanese National Phase Publication No. 2001-519539, JP-A No. 2008-96953, and the like can be referred to.

Next, each member or material, which is used in the optical element of the present invention, is described.

<Hydrophobic Insulating Film>

The hydrophobic insulating film in the present invention is a film that is provided at least at a portion on the conductive surface side of the first substrate, and is a film that contacts with the oil.

The term “hydrophobic” used in the present invention is not particularly limited, but refers to the property of, for example, the water contact angle of 60° or more (preferably 70° or more, and more preferably 80° or more).

Specifically, the water contact angle is measured in accordance with the method described in “6. Sessile drop method” in JIS R3257 “Testing method of wettability of glass substrate surface”.

More specifically, using a contact angle measuring device (trade name: Contact Angle Meter CA-A, manufactured by Kyowa Interface Science Co., Ltd.), a water droplet having a size of 20 points is made, then the water droplet is put out from the tip of a needle and is brought into contact with the hydrophobic insulating film to form a water droplet, which is allowed to stand for 10 seconds, and thereafter, the shape of the water droplet is observed from the peephole of the contact angle meter, whereby the contact angle θ at 25° C. is determined.

Further, the term “insulating” used in the present invention is not particularly limited, but refers to the property of, for example, the specific resistance of 10⁷ Ω·cm or more (preferably 10⁸ Ω·cm or more, and more preferably 10⁹ Ω·cm or more). The specific resistance can be measured in accordance with, for example, JISC2526.

The hydrophobic insulating film has a crosslinking structure which is derived from a polyfunctional compound having two or more polymerizable groups. Thus, the deterioration of the hydrophobic insulating film when application of a voltage is repeatedly performed is suppressed, as compared with a case in which the hydrophobic insulating film does not have a crosslinking structure (for example, a case in which only a linear polymer is used as the polymer included in the hydrophobic insulating film).

The crosslinking structure is suitably formed by polymerizing at least one polyfunctional compound having two or more polymerizable groups (as necessary, together with other monomer).

(Polyfunctional Compound)

The polyfunctional compound has two or more polymerizable groups (in one molecule).

Examples of the polymerizable groups include radical-polymerizable groups, cation-polymerizable groups, and condensation-polymerizable groups. Among them, a (meth)acryloyl group, an allyl group, an alkoxysilyl group, an α-fluoroacryloyl group, an epoxy group, —C(O)OCH═CH₂, and the like are preferable.

The two or more polymerizable groups included in the polyfunctional compound may be the same as or different from each other.

In the formation of the crosslinking structure described above, the polyfunctional compounds may be used alone or in a combination of two or more of them.

As the polyfunctional compound, a known polyfunctional, polymerizable compound (a radical-polymerizable compound, a cation-polymerizable compound, a condensation-polymerizable compound, or the like) can be used.

Examples of the polyfunctional compound include, for example, polyfunctional acrylates such as ethylene glycol di(meth)acrylate, diethylene glycol di(meth)acrylate, polyethylene glycol di(meth)acrylate, 1,6-hexanediol di(meth)acrylate, ethoxylated 1,6-hexanediol diacrylate, neopentyl glycol di(meth)acrylate, ethoxylated neopentyl glycol di(meth)acrylate, propoxylated neopentyl glycol di(meth)acrylate, tripropylene glycol di(meth)acrylate, polypropylene glycol diacrylate, 1,4-butanediol di(meth)acrylate, 1,9-nonanediol diacrylate, tetraethylene glycol diacrylate, 2-n-butyl-2-ethyl-1,3-propanediol diacrylate, dimethyloltricyclodecane diacrylate, neopentyl glycol hydroxypivalate diacrylate, 1,3-butylene glycol di(meth)acrylate, ethoxylated bisphenol-A di(meth)acrylate, propoxylated bisphenol-A di(meth)acrylate, cyclohexane dimethanol di(meth)acrylate, dimethyloldicyclopentane diacrylate, trimethylolpropane triacrylate, ethoxylated trimethylolpropane triacrylate, propoxylated trimethylolpropane triacrylate, pentaerythritol triacrylate, terramethylolpropane triacrylate, terramethylolmethane triacrylate, pentaerythritol tetraacrylate, caprolactone modified trimethylolpropane triacrylate, ethoxylated isocyanuric acid triacrylate, tris(2-hydroxyethyl) isocyanurate triacrylate, propoxylated glycerol triacrylate, tetramethylolmethane tetraacrylate, ditrimethylolpropane tetraacrylate, ethoxylated pentaerythritol tetraacrylate, dipentaerythritol hexaacrylate, neopentyl glycol oligoacrylate, 1,4-butanediol oligoacrylate, 1,6-hexanediol oligoacrylate, trimethylolpropane oligoacrylate, pentaerythritol oligoacrylate, urethane acrylate, epoxy acrylate, polyester acrylate and the like.

As the polyfunctional compound, other than the above compounds, a polyfunctional, polymerizable compound selected as appropriate from known polymerizable compounds described in, for example, paragraphs 0031 to 0035 of JP-A No. 2008-181067, paragraphs 0149 to 0155 of JP-A No. 2008-139378, and paragraphs 0142 to 0146 of JP-A No. 2010-134137, and the “other monomers being allowed to undergo copolymerization” described below can be used.

It is preferable that the polyfunctional compound in the present invention has three or more (preferably four or more, and more preferably five or more) polymerizable groups (in one molecule). Thereby, the density of the crosslinking structure in the film can be further increased, and therefore, the deterioration of the hydrophobic insulating film when application of a voltage is repeatedly performed may be further suppressed.

The polyfunctional compound in the present invention is preferably a fluorine-containing compound, and more preferably a polyfunctional compound in which the percentage of the fluorine content is 30% by mass or higher (preferably, 35% by mass or higher, more preferably, 40% by mass or higher, and even more preferably, 45% by mass or higher) based on the molecular weight.

When the polyfunctional compound includes fluorine atoms (specifically, when the percentage of the fluorine content is 30% by mass or higher based on the molecular weight), the hydrophobicity of the hydrophobic insulating film is further enhanced.

There is no particular limitation as to the upper limit of the percentage of the fluorine content in the polyfunctional compound, but the upper limit may be, for example, 60% by mass (preferably 55% by mass, and more preferably 50% by mass) based on the molecular weight.

A preferable form of the fluorine-containing compound is a form having an atomic group (hereinafter, may also be referred to as a “fluorine-containing core portion”), which includes a fluorine atom and a carbon atom, and is not substantially involved in polymerization; and three or more polymerizable groups, which have polymerizability such as radical polymerizability, cation polymerizability, or condensation polymerizability, and connected to the fluorine-containing core portion through a linking group such as an ester bond or an ether bond. The fluorine-containing core portion may further include other atom such as at least one of oxygen atom and hydrogen atom.

The polyfunctional compound in the present invention is preferably a polyfunctional compound represented by the following Formula (A) (hereinafter, may merely be referred to as a “compound represented by Formula (A)”). The polyfunctional compound represented by the following Formula (A) is a fluorine-containing compound.

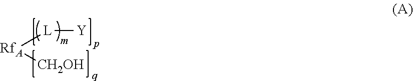

In Formula (A), Rf_{A} represents a (p+q)-valent linear or cyclic linking group containing a carbon atom and a fluorine atom. In Formula (A), p represents an integer of 3 or more; q represents an integer of 0 or more; and m represents 0 or 1. In Formula (A), L represents a divalent linking group, and Y represents a polymerizable group.

In Formula (A), Rf_{A} may include other atom(s) in addition to a carbon atom and a fluorine atom. In a case, the other atom preferably includes at least one of oxygen atom or hydrogen atom. In the case, Rf_{A} is a group which corresponds to the fluorine-containing core portion.

As the Rf_{A}, a (p+q)-valent linear or cyclic fluorohydrocarbon group; a (p+q)-valent linear or cyclic linking group obtained by a combination of a fluorohydrocarbon group and —O—; or a (p+q)-valent linear or cyclic linking group obtained by a combination of a fluorohydrocarbon group, a hydrocarbon group and —O— is preferable, and a (p+q)-valent linear or cyclic fluorohydrocarbon group; or a (p+q)-valent linear or cyclic linking group obtained by a combination of a fluorohydrocarbon group and —O— is more preferable.

Here, in the present specification, the fluorohydrocarbon group is referred to as a group having a configuration of a hydrocarbon group of which at least one of hydrogen atom is substituted with a fluorine atom.

In a case in which the Rf_{A} includes a hydrogen atom, the number of hydrogen atoms/the number of fluorine atoms is not particularly limited, but preferably 1/4 or less, and more preferably 1/9 or less from a viewpoint of further improving of antifouling property.

In Formula (A), p is preferably an integer of 3 to 6 and more preferably an integer of 3 to 4. q is preferably an integer of 0 to 3, more preferably 0 or 1, and even more preferably 0. (p+q) is preferably an integer of 3 to 6 and more preferably an integer of 3 to 4.

In Formula (A), Y is preferably a polymerizable group selected from a radical-polymerizable group, a cation-polymerizable groups and a condensation-polymerizable group, and more preferably a (meth)acryloyl group, an allyl group, an alkoxysilyl group, an α-fluoroacryloyl group, an epoxy group or —C(O)OCH═CH₂.

In Formula (A) above, L represents a divalent linking group, and preferably represents an alkylene group having from 1 to 10 carbon atoms, an arylene group having from 6 to 10 carbon atoms, —O—, —S—, —N(R)—, or a group obtained by the combination of an alkylene group having from 1 to 10 carbon atoms and at least one of —O—, —S—, or —N(R)—, or a group obtained by the combination of an arylene group having from 6 to 10 carbon atoms and at least one of —O—, —S—, or —N(R)— (R represents a hydrogen atom or an alkyl group having from 1 to 5 carbon atoms). L preferably represents an alkylene group having from 1 to 10 carbon atoms, an arylene group having from 6 to 10 carbon atoms, —O—, —S—, —N(R)—, or a group obtained by the combination of an alkylene group having from 1 to 10 carbon atoms and at least one of —O—, —S—, or —N(R)—.

The polyfunctional compound in the present invention is more preferably a polyfunctional compound represented by the following Formula (B) (hereinafter, may merely be referred to as a “compound represented by Formula (B)”).

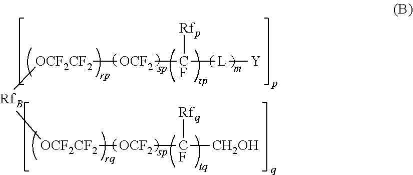

In Formula (B), Rf_{B} represents a (p+q)-valent linear or cyclic saturated perfluorohydrocarbon group or a (p+q)-valent linear or cyclic linking group obtained by a combination of a saturated perfluorohydrocarbon group and —O—. In Formula (B), each of Rfₚ and Rf_{q} independently represents a monovalent linear or cyclic group containing a carbon atom and a fluorine atom. In Formula (B), each of rp and rq independently represents an integer of 0 to 100; each of sp and sq independently represents 0 or 1; each of tp and tq independently represents 0 or 1. In Formula (B), each of Y, L, p, q and m has the same definition as each of Y, L, p, q and m as defined in Formula (A) respectively, and the preferable range of contents thereof are also the same as those thereof in Formula (A) respectively. In Formula (B), a configuration order of (OCF₂CF₂), (OCF₂) and (CFRfₚ) in each of groups of p number, and a configuration order of (OCF₂CF₂), (OCF₂) and (CFRf_{q}) in each of groups of q number are not particularly restricted.

In the present specification, the saturated perfluorohydrocarbon group is referred to as a group having a configuration of a saturated hydrocarbon group of which all the hydrogen atoms are substituted with fluorine atoms. In Formula (B), each of Rfₚ and Rf_{q} may further independently include other atom(s) in addition to a carbon atom and a fluorine atom. In a case, the other atom preferably includes at least one of oxygen atom or hydrogen atom.

As each of the Rfₚ and Rf_{q}, a monovalent linear or cyclic fluorohydrocarbon group; a monovalent linear or cyclic group obtained by a combination of a fluorohydrocarbon group and —O—; or a monovalent linear or cyclic group obtained by a combination of a fluorohydrocarbon group, a hydrocarbon group and —O— is preferable, and a monovalent linear or cyclic fluorohydrocarbon group, or a monovalent linear or cyclic group obtained by a combination of a fluorohydrocarbon group and —O— is more preferable.

Each of the Rfₚ and Rf_{q} is independently preferably a straight chain or branched perfluoroalkyl group having 1 to 12 carbon atoms (for example, a trifluoromethyl group; a perfluoroethyl group, a perfluoropropyl group and the like); a perfluorocycloalkyl group having 3 to 12 carbon atoms (for example, a perfluorocyclopentyl group, a perfluorocyclohexyl group and the like), more preferably a straight chain or branched perfluoroalkyl group having 1 to 12 carbon atoms, and most preferably a trifluoromethyl group.

In Formula (B), while each of rp and rq independently represents an integer of 0 to 100, each of rp and rq is preferably an integer of 0 to 20 respectively, more preferably an integer of 1 to 5 respectively, and even more preferably 1. In Formula (B), each of sp and sq independently represents 0 or 1, and is preferably 0 respectively. Each of tp and tq independently represents 0 or 1, and is preferably 0 respectively.

A preferable form in Formula (A) described above is a form in which p is an integer of 3 to 6, and q is 0. A preferable form in Formula (B) described above is a form in which p is an integer of 3 to 6, q is 0, and each of rp and rq is independently an integer of 1 to 5.

The polyfunctional compound in the present invention is even more preferably a polyfunctional compound represented by the following Formula (1) (hereinafter, may merely be referred to as a “compound represented by Formula (1)”).

RfLₘY]ₙ (1)

In Formula (1), Rf represents an n-valent linear or cyclic linking group containing a carbon atom and a fluorine atom. In Formula (1), n represents an integer of 3 or more. In Formula (1), each of Y, L and m has the same definition as each of Y, L and m as defined in Formula (A) respectively, and the preferable range of contents thereof are also the same as those thereof in Formula (A) respectively.

In Formula (1), n is preferably an integer of 3 to 10, more preferably an integer of 3 to 6, and particularly preferably an integer of 3 to 4.

In Formula (1), Rf may further include other atom(s) in addition to a carbon atom and a fluorine atom. In a case, the other atom preferably includes at least one of oxygen atom or hydrogen atom. In the case, Rf is a group which corresponds to the fluorine-containing core portion.

As the Rf, an n-valent linear or cyclic fluorohydrocarbon group; an n-valent linear or cyclic linking group obtained by a combination of a fluorohydrocarbon group and —O—; or an n-valent linear or cyclic linking group obtained by a combination of a fluorohydrocarbon group, a hydrocarbon group and —O— is preferable, and an n-valent linear or cyclic fluorohydrocarbon group, or an n-valent linear or cyclic linking group obtained by a combination of a fluorohydrocarbon group and —O— is more preferable.

In a case in which the Rf includes a hydrogen atom, the number of hydrogen atoms/the number of fluorine atoms is not particularly limited, but preferably 1/4 or less, and more preferably 1/9 or less from a viewpoint of further improving of antifouling property.

Rf preferably represents such a group that all the intercrosslink molecular weights are each 300 or less when the polyfunctional compound represented by Formula (1) is polymerized by using all the polymerizable groups. The intercrosslink molecular weight is described below.

Specifically representative examples of Rf include the following specific examples.

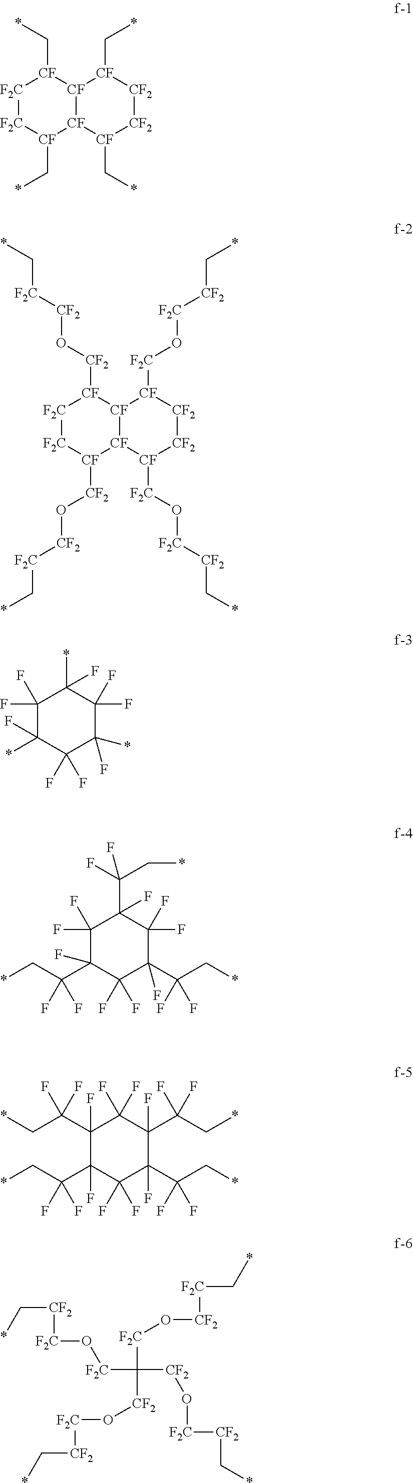

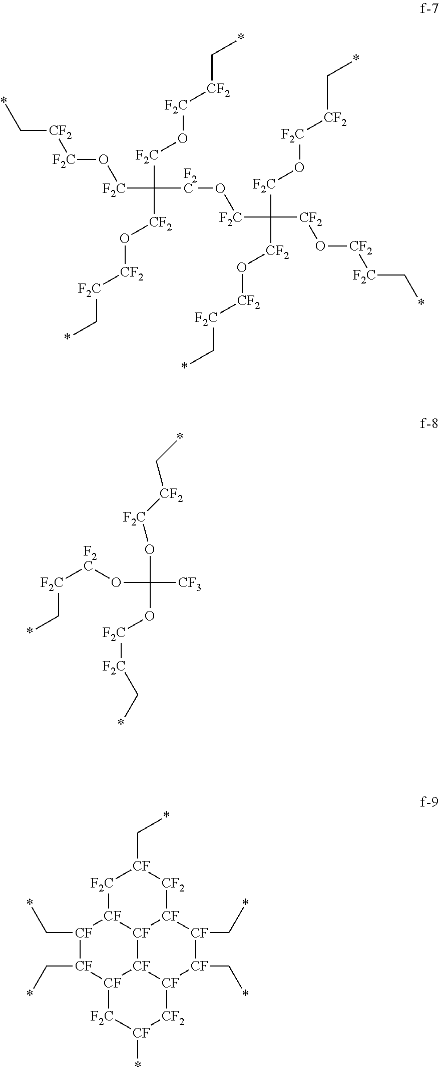

In the above Formula f-1 to the above Formula f-9, in a case in which m represents 1, * represents a bonding site to bond to L, and in a case in which m represents 0, * represents a bonding site to bond to Y.

In a case in which Rf in Formula (1) above is a group which has a valency of n and is selected from the above Formula f-1 to the above Formula f-9, n represents an integer of 3 to 6.

From the viewpoints of the refractive index and polymerizability, the polyfunctional compound represented by Formula (1) above is more preferably a polyfunctional compound represented by Formula (2) or Formula (3).

RfCH₂—OC(O)CH═CH₂]ₙ (2)

RfC(O)OCH═CH₂]ₙ (3)

In Formula (2) and Formula (3), Rf and n respectively have the same definition as Rf and n as defined in Formula (1).

A preferable specific example of the polyfunctional compound in the invention {a compound represented by any one of the following Formula (M-1) to Formula (M-13) and the following Formula (M-24) to Formula (M-75); in some cases, it is referred as exemplary compounds (M-1)˜(M-13) or exemplary compounds (M-24)˜(M-75)} is shown below, but the invention is not limited thereto.

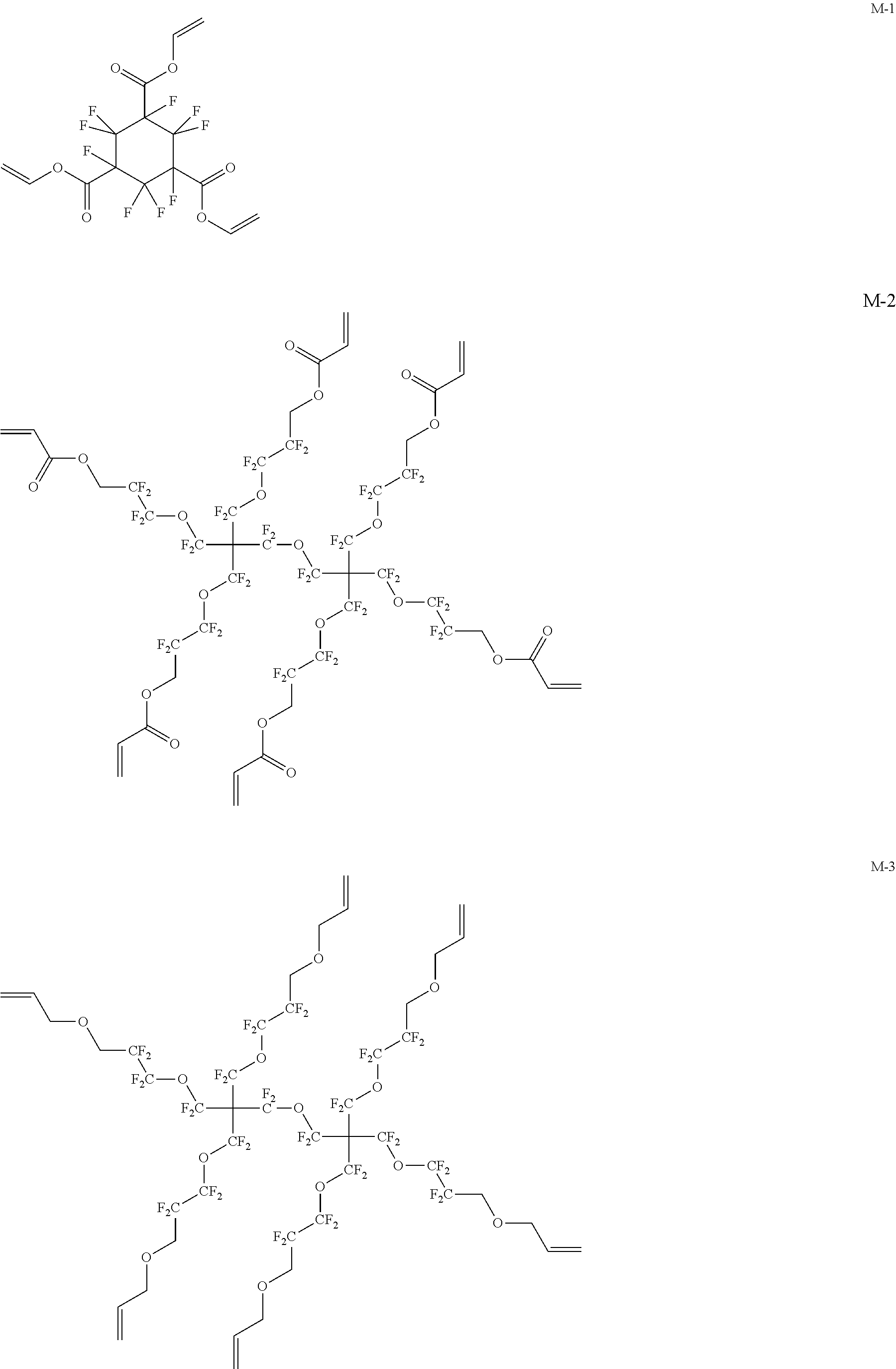

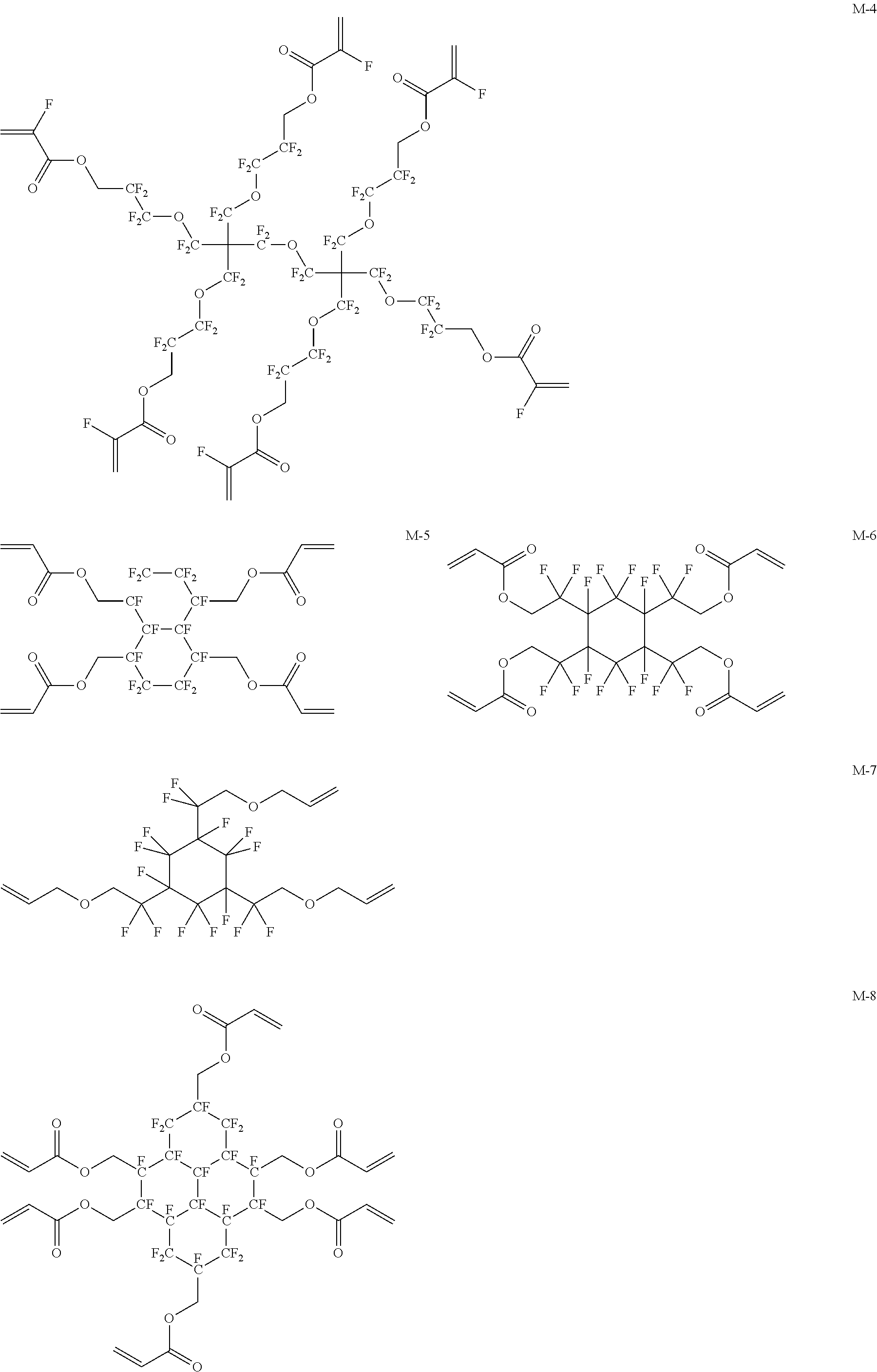

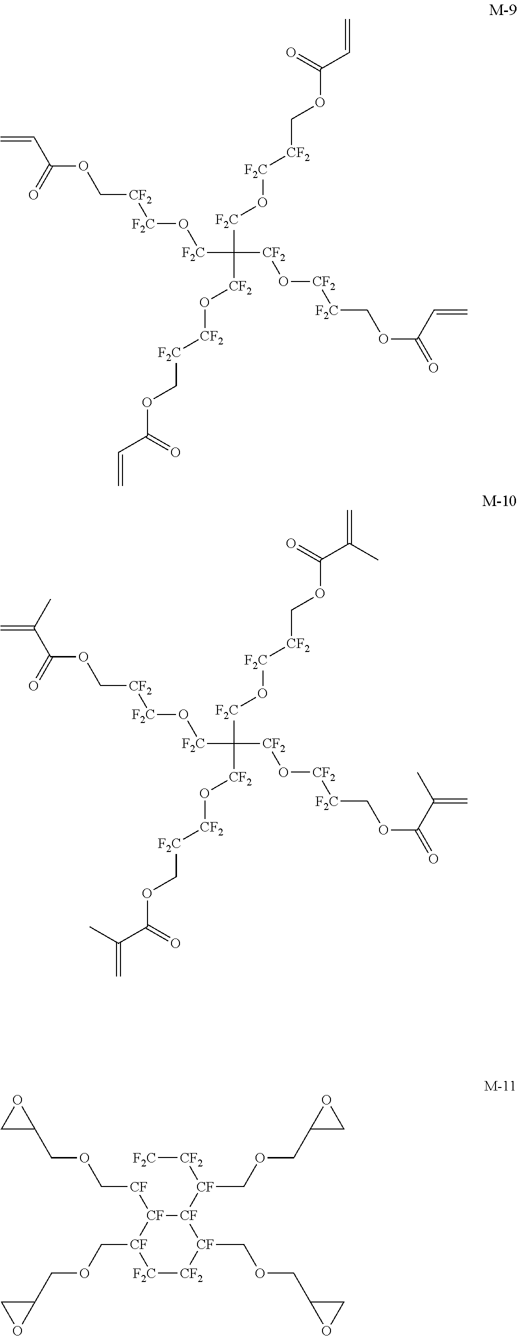

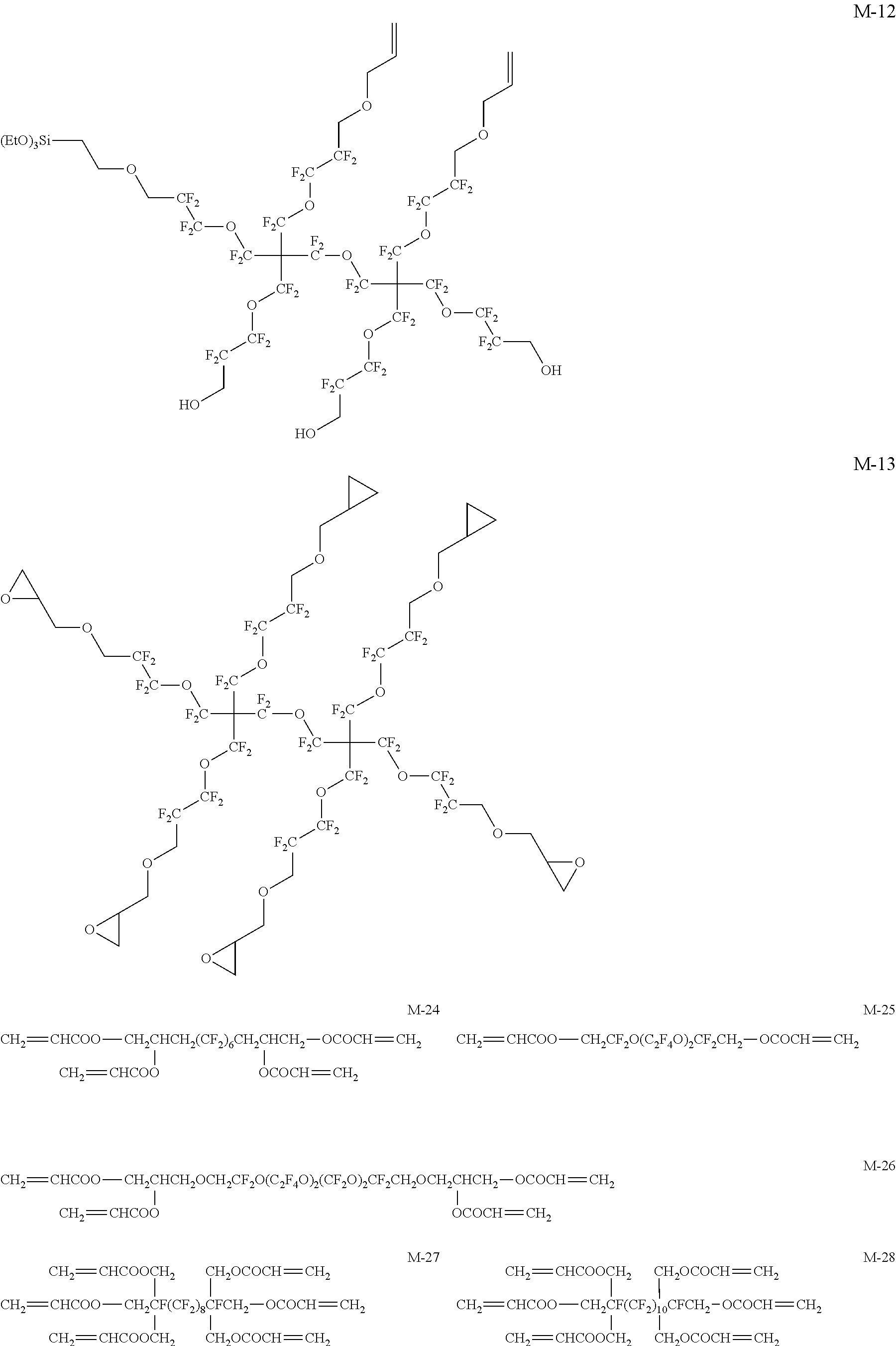

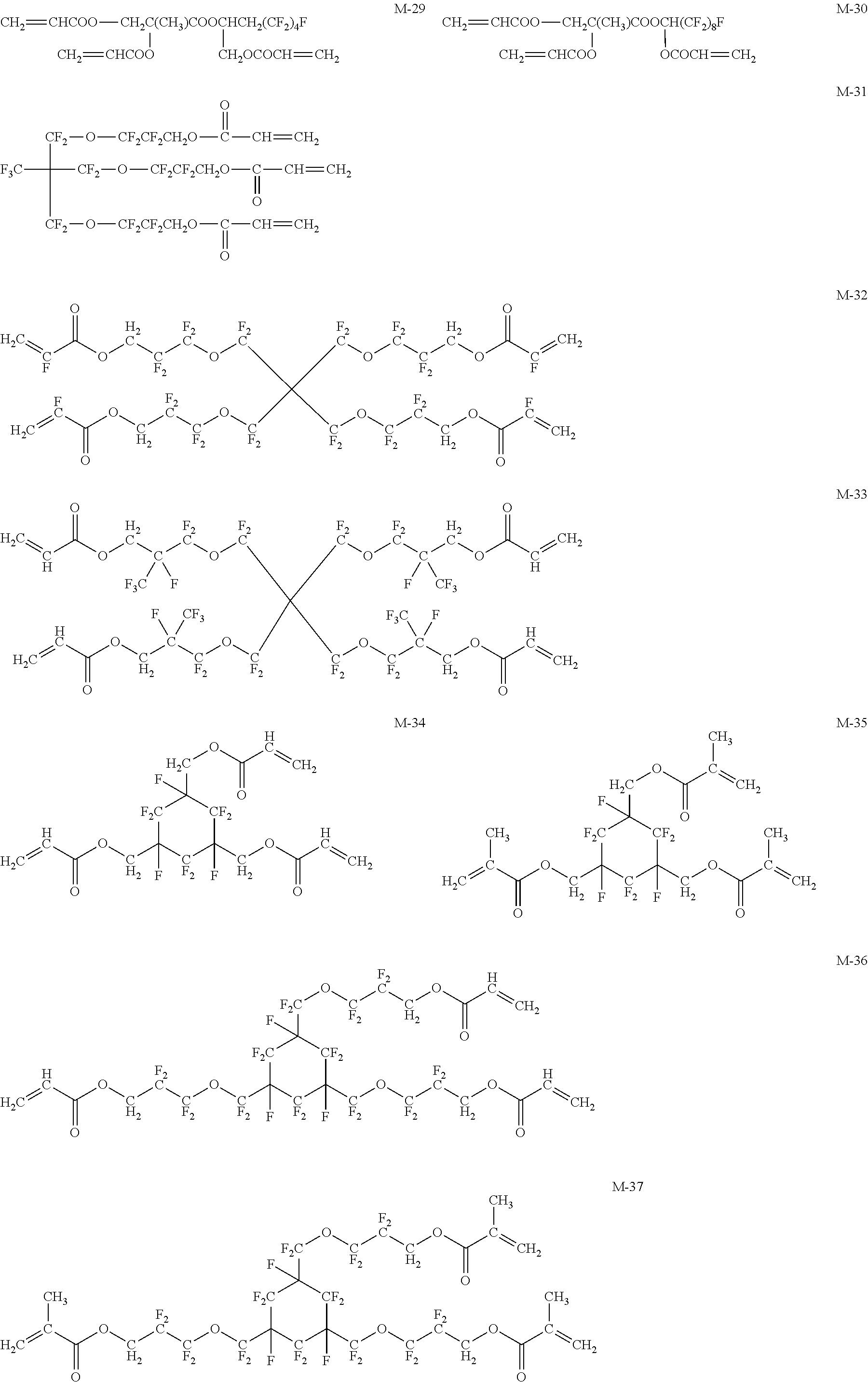

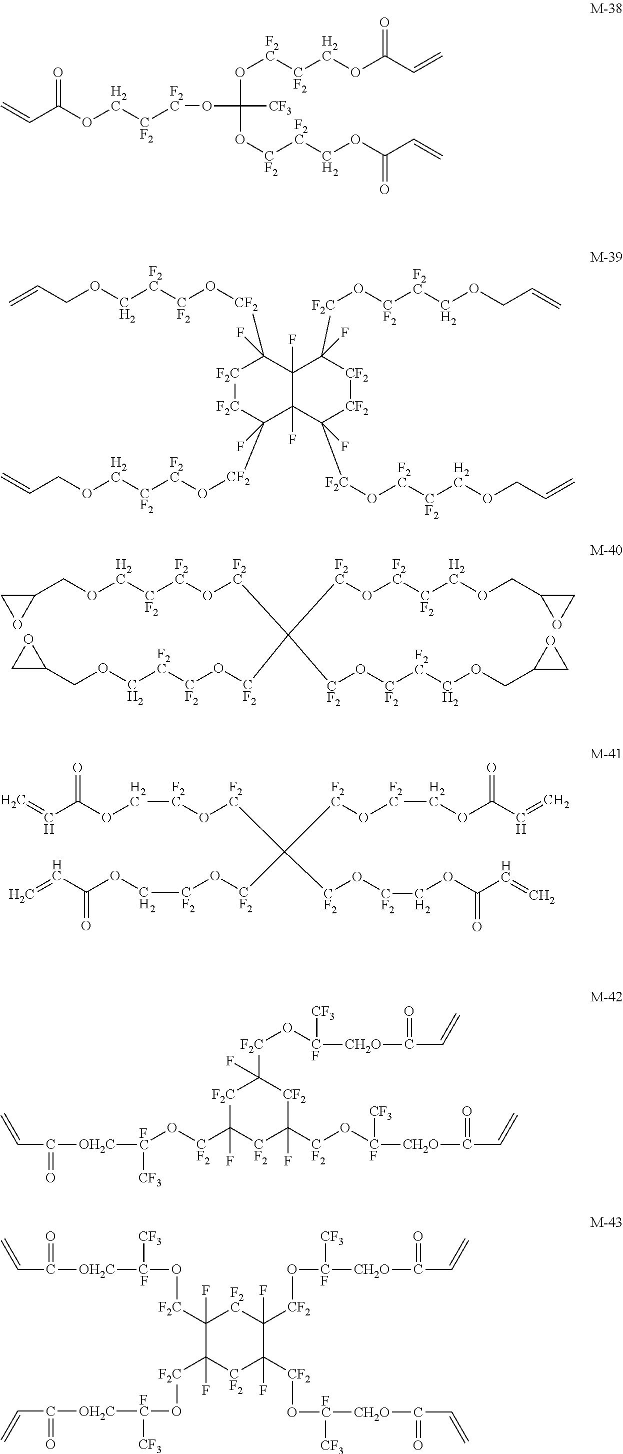

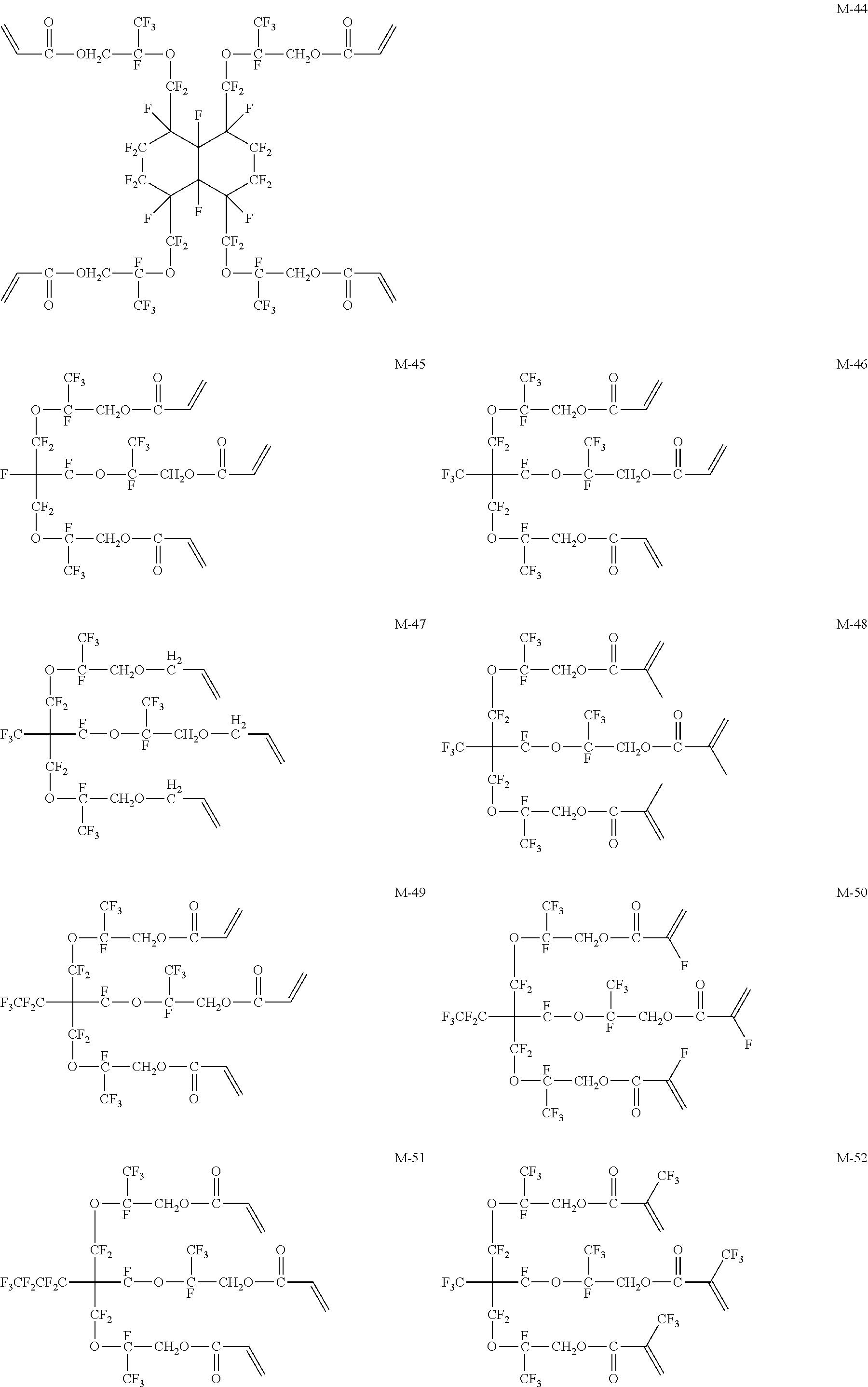

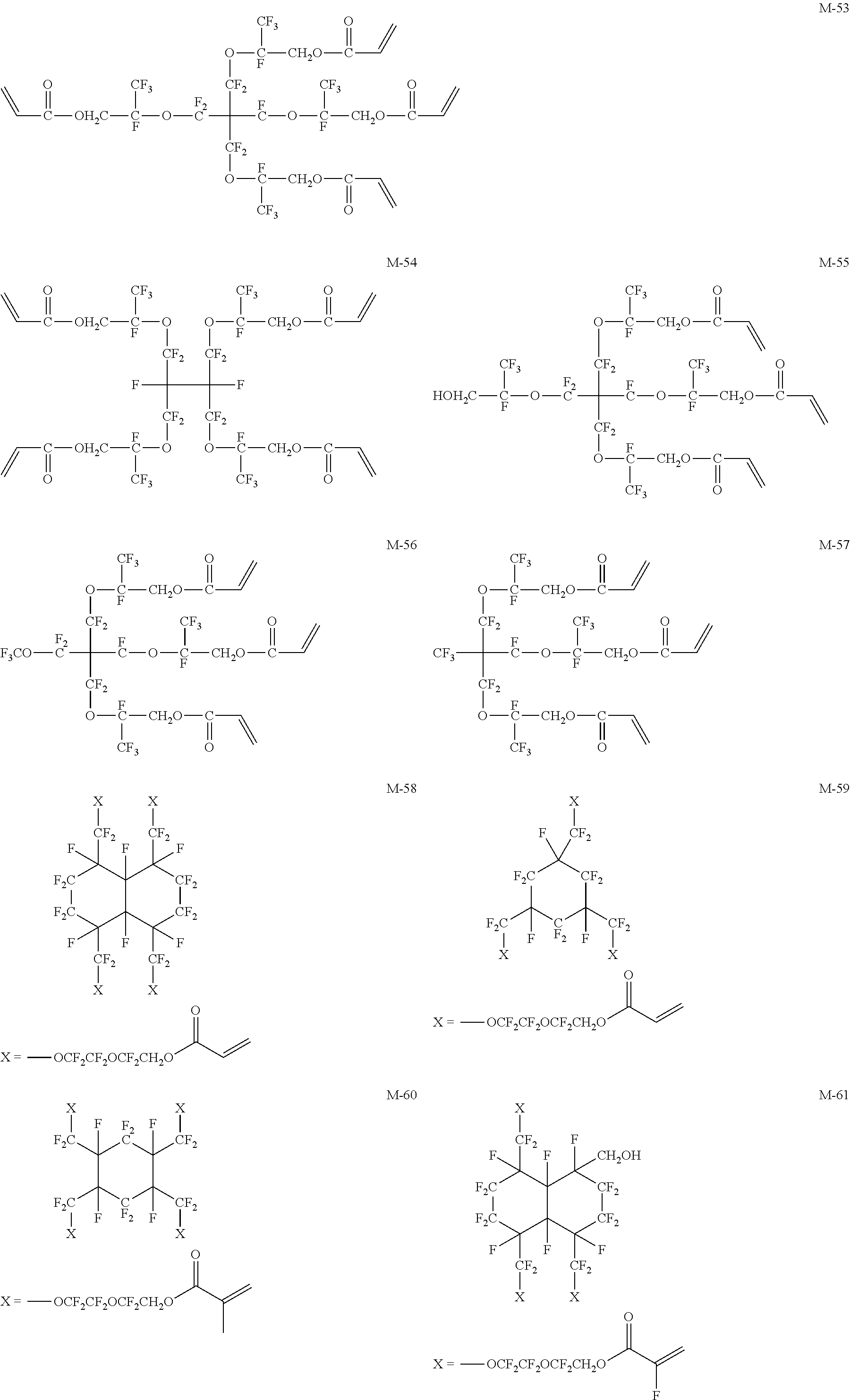

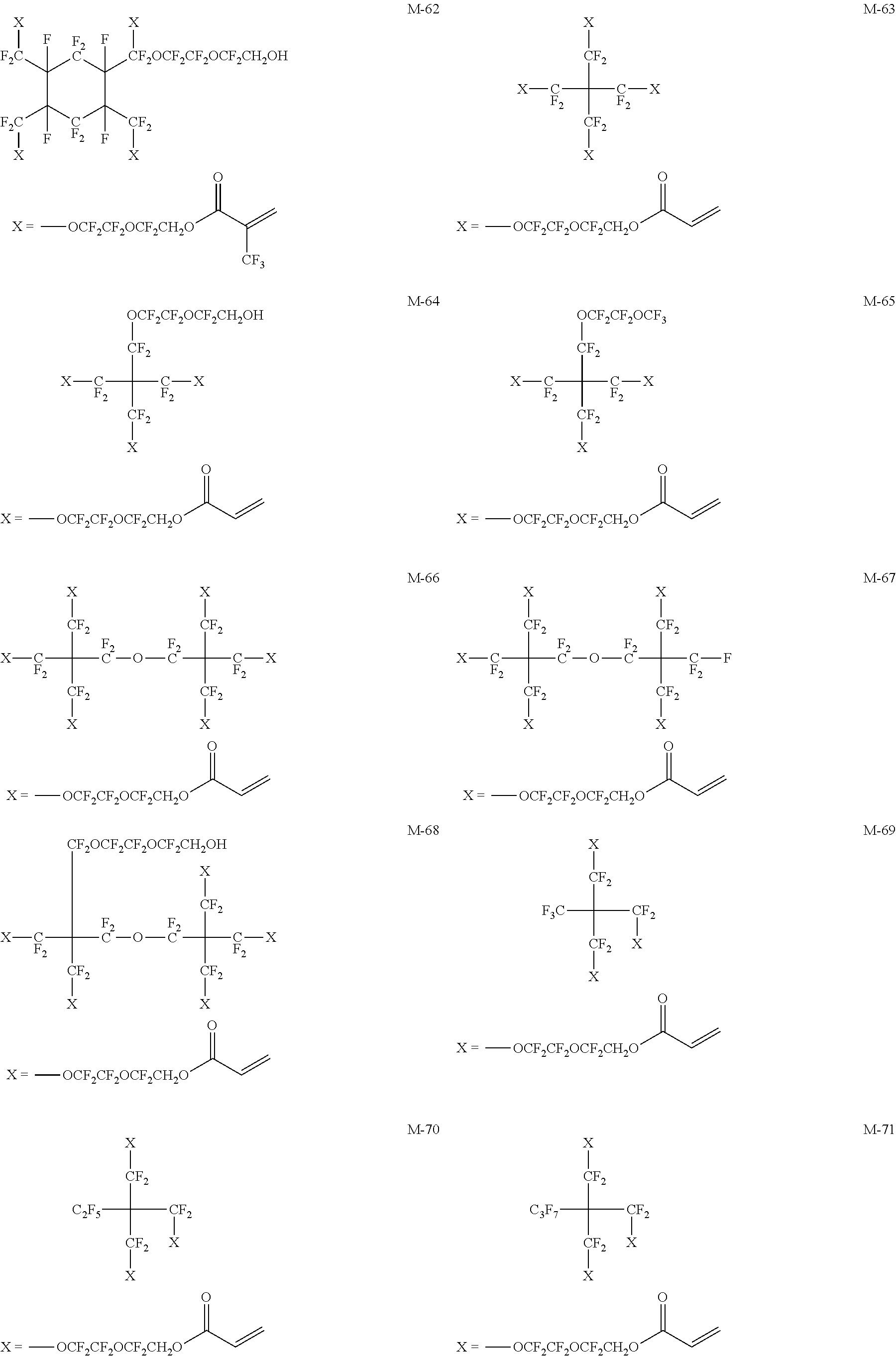

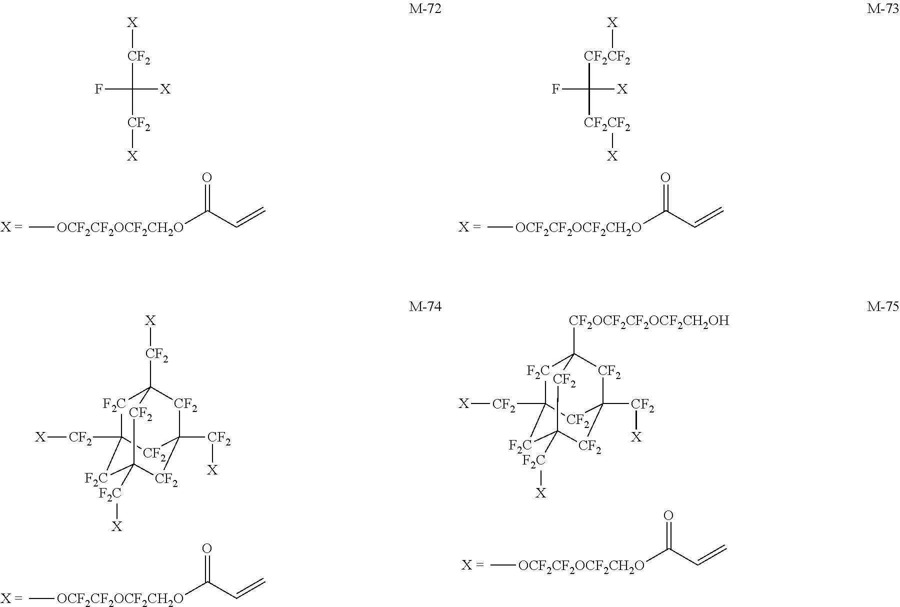

The percentages of the fluorine content (% by mass, hereinafter, it may merely be referred to as “%” in some cases) in the exemplary compounds (M-1)˜(M-13) and (M-24) (M-75) is listed below.

| | | | | |
|---|---|---|---|---|
| M-1: 37.5%, | M-2: 46.2%, | M-3: 48.6%, | M-4: 49.8%, | M-5: 36.6%, |
| M-6: 39.8%, | M-7: 47.0%, | M-8: 35.1%, | M-9: 44.9%, | M-10: 42.5%, |
| M-11: 36.2%, | M-12: 47.7%, | M-13: 45.8%, | M-24: 34.2%, | M-25: 44.0%, |
| M-26: 34.1%, | M-27: 31.4%, | M-28: 35.6%, | M-29: 30.6%, | M-30: 45.9%, |
| M-31: 47.8%, | M-32: 48.9%, | M-33: 50.0%, | M-34: 34.3%, | M-35: 31.7%, |
| M-36: 51.5%, | M-37: 49.4%, | M-38: 41.7%, | M-39: 54.4%, | M-40: 44.5%, |
| M-41: 37.3%, | M-42: 51.5%, | M-43: 49.5%, | M-44: 51.9%, | M-45: 46.0%, |
| M-46: 47.8%, | M-47: 50.4%, | M-48: 45.5%, | M-49: 49.4%, | M-50: 52.7%, |
| M-51: 50.9%, | M-52: 54.9%, | M-53: 44.9%, | M-54: 46.3%, | M-55: 48.0%, |
| M-56: 48.6%, | M-57: 52.1%, | M-58: 52.8%, | M-59: 52.5%, | M-60: 49.1%, |
| M-61: 54.9%, | M-62: 56.7%, | M-63: 47.5%, | M-64: 49.6%, | M-65: 51.6%, |
| M-66: 48.4%, | M-67: 49.0%, | M-68: 49.7%, | M-69: 49.7%, | M-70: 50.9%, |
| M-71: 52.0%, | M-72: 46.9%, | M-73: 49.7%, | M-74: 51.7%, | M-75: 50.1%. |

The polyfunctional compound according to the present invention is preferably a polyfunctional compound in which all the calculated values for the intercrosslink molecular weight are each 300 or less (more preferably a fluorine-containing compound) when polymerization is performed by using the polymerizable groups, from the viewpoint of crosslink density. Herewith, the hardness is further improved, and the deterioration of the hydrophobic insulating film during repeated actions is further suppressed.

Further, the polyfunctional compound is more preferably a fluorine-containing compound in which the percentage of the fluorine content is 30% by mass or higher (more preferably 35% by mass or higher) based on the molecular weight, and all calculated values for the intercrosslink molecular weight (molecular weight between crosslinkings) are respectively 300 or less when polymerization is performed by using the two or more polymerizable groups to form a crosslinking structure.

Here, the calculated value for the intercrosslink molecular weight refers to a molecular weight of an atomic group sandwiched between (a) and (a), (b) and (b), or (a) and (b) in a polymer obtained by polymerizing the polyfunctional compound by using the polymerizable groups, wherein (a) represents a carbon atom that bonds with 3 or more carbon atoms or silicon atoms in total, and (b) represents a silicon atom that bonds with 3 or more carbon atoms or oxygen atoms in total.

Note that, the “carbon atom that bonds with 3 or more carbon atoms or silicon atoms in total” indicates a carbon atom in which 3 or more bonds thereof, among 4 bonds, are each a bond with a carbon atom or a silicon atom, and the “silicon atom that bonds with 3 or more carbon atoms or oxygen atoms in total” indicates a silicon atom in which 3 or more bonds thereof, among 4 bonds, are each a bond with a carbon atom or an oxygen atom.

The intercrosslink molecular weight is explained with reference to, for example, among the above-described polyfunctional compounds, the exemplified compound M-2.

Assuming that the exemplified compound M-2 is polymerized by using all the polymerizable groups included in one molecule, the polymer to be obtained is represented by Formula (4).

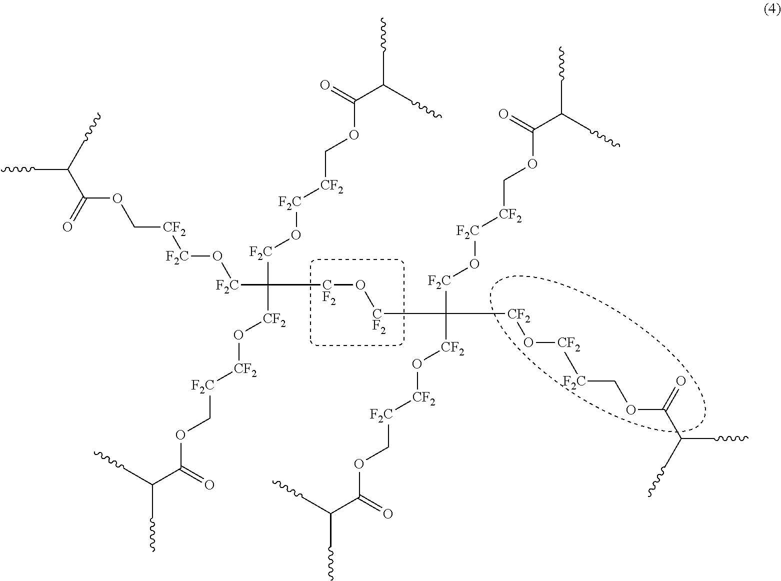

In this case, the partial structure to be an object for the calculation of the intercrosslink molecular weight defined as described above is the portion surrounded by the dashed line in Formula (4), and the calculated values for the intercrosslink molecular weight are C₂F₄O=116.0 and C₅H₂F₆O₃=224.1, respectively, each of which is 300 or less.

Preferable examples of the polyfunctional compounds of which the calculated values for the intercrosslink molecular weight are 300 or less, include the exemplary compounds of from (M-1) to (M-13) described above.

With regard to each of the exemplified compounds M-1 to M-13, the intercrosslink molecular weight (in a case in which plural intercrosslink molecular weights exist, the maximum value among them) when all the polymerizable groups contained in one molecule undergo polymerization is determined. The results are as follows.

Namely, the crosslink molecular weights are 50.0 (M-1), 224.1 (M-2), 210.1 (M-3), 224.1 (M-4), 100.0 (M-5), 91.0 (M-6), 94.1 (M-7), 58.0 (M-8), 224.1 (M-9), 224.1 (M-10), 100.0 (M-11), 224.1 (M-12), 210.1 (M-13), respectively.

The calculated value for the intercrosslink molecular weight is more preferably 250 or less, and even more preferably 200 or less.

In a case in which the polyfunctional compound is a fluorine-containing compound {for example, a compound represented by Formula (A) (A compound represented by Formula (B) and a compound represented by Formula (1) are included. Herein after, this definition may be applied to the similar case in same manner.)}, there is no particular limitation as to the method of producing the fluorine-containing compound but, for example, the following method is preferable.

Namely, a method of substituting for 80 mol % or more (preferably, 90 mol % or more) of hydrogen atoms of a compound having an ester bond, a dialkoxy group, and/or a halogen atom with fluorine atoms by liquid-phase fluorination, and then introducing 3 or more (preferably 4 or more, and more preferably 5 or more) polymerizable groups is preferable.

The liquid-phase fluorination is described, for example, in U.S. Pat. No. 5,093,432.

The compound to be subjected to the liquid-phase fluorination should be a compound that dissolves in a fluorine-based solvent used for liquid-phase fluorination or a liquid compound, but except that, there is no particular limitation. From the viewpoints of such solubility and reactivity, a compound that originally contains fluorine may also be used. Further, a compound having an ester bond, a dialkoxy group, and/or a halogen atom is preferable, since the compound may have a reactive point for introducing a polymerizable group after the liquid-phase fluorination.

With the introduction of fluorine atoms by the liquid-phase fluorination, it is possible to extremely increase the percentage of the fluorine content in the portion other than the polymerizable groups which are to be introduced afterward.

—Polymer Derived from Polyfunctional Compound—

The polyfunctional compound described above may be allowed to undergo polymerization by various polymerization methods, and may be contained in the hydrophobic insulating film as a polymer derived from the polyfunctional compound. In the polymerization, the polyfunctional compound may be used alone for polymerization, or may be used for copolymerization, and further, the polyfunctional compound may also be used as a crosslinking agent.

In a case in which the compound represented by Formula (A) is used as the polyfunctional compound, the polymer contained in the hydrophobic insulating film may be a homopolymer of the compound represented by Formula (A), or may be a copolymer obtained by using the compound represented by Formula (A) and other monomer.

As the other monomer being allowed to undergo copolymerization, a conventionally known monomer can be used. Examples of a specifically representative monomer include radical-polymerizable monomers such as methyl (meth)acrylate, ethyl (meth)acrylate, propyl (meth)acrylate, 2-trifluoroethyl(meth)acrylate, 2,3-pentafluoropropyl(meth)acrylate, 1H,1H,5H-octafluoropentyl(meth)acrylate, 1H,1H,7H-dodecafluoroheptyl(meth)acrylate, 1H,1H,9H-hexadecafluorononyl(meth)acrylate, 2-(perfluorobutyl)ethyl(meth)acrylate, 2-(perfluorohexyl)ethyl(meth)acrylate, 2-(perfluorooctyl)ethyl(meth)acrylate, allyl alcohol, ethylallyl alcohol, α-fluoroacrylic acid methyl ester, vinyl acetate, ethyl vinyl ketone, or butyl vinyl ketone;

tetraethoxysilane, ethyl trimethoxy silane, chloro trimethoxy silane, amino propyl triethoxy silane, vinyl trimethoxy silane, γ-glycidoxy propyl triethoxy silane, γ-methacryloyloxy propyl trimethoxy silane, γ-mercapto propyl trimethoxy silane, or condensation-polymerizable monomers such as monomers represented by the following chemical formulae;

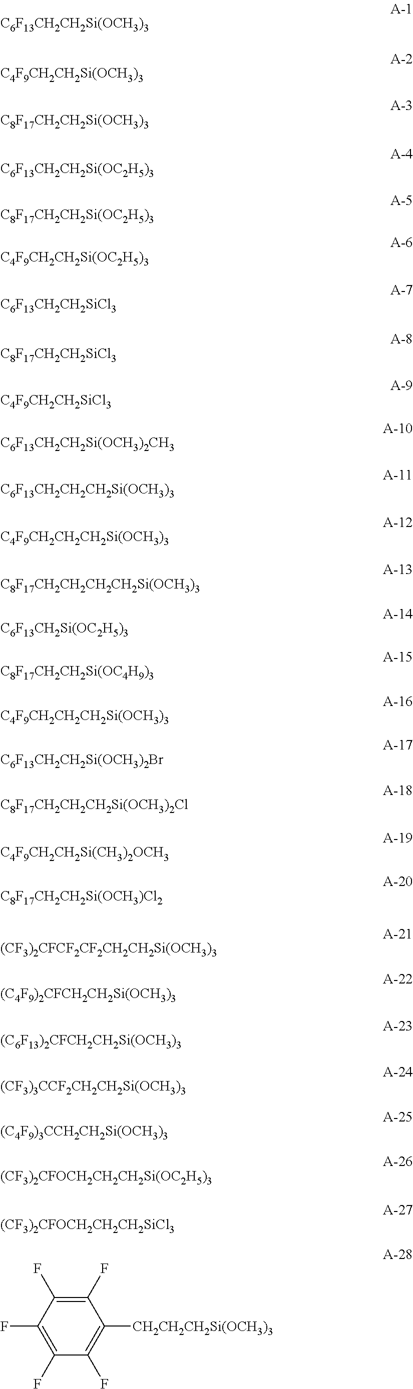

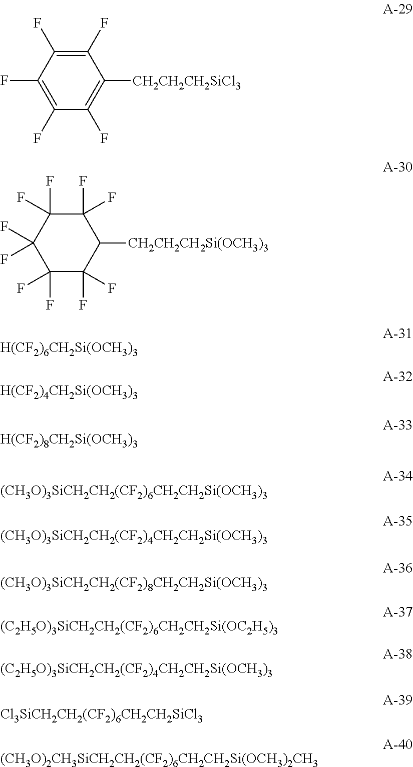

and cation-polymerizable monomers such as glycerol diglycidyl ether, glycerol triglycidyl ether, 1,1,1-trimethylolpropane triglycidyl ether, sorbitol polyglycidyl ether, bisphenol A diglycidyl ether, hydroquinone diglycidyl ether, resorcin diglycidyl ether, fluoroglycinol triglycidyl ether, triglycidyl isocyanurate, ethyl vinyl ether, or cyclohexyl vinyl ether. Among them, from the viewpoint of polymerizability, radical- or cation-polymerizable monomers are preferable, and radical-polymerizable monomers are more preferable.

The method of polymerizing the polyfunctional compound is preferably bulk polymerization, or solution polymerization.

The method of initiating polymerization may be, for example, a method using a polymerization initiator (for example, a radical initiator), a method of irradiating with light or a radiation, a method of adding an acid, a method of adding a photo acid generator and then irradiating with light, or a method of heating to undergo dehydration condensation. These polymerization methods and polymerization initiation methods are described in, for example, “Kobunshi Gosei Hoho (Polymer Synthesis Method)” by Teiji Tsuruta, revised edition (published by Nikkan Kogyo Shimbun, Ltd., 1971) and “Kobunshi Gosei no Jikkenho (Experimental Technique of Polymer Synthesis)” by Takayuki Ohtu and Masaetu Kinoshita, Kagaku-Dojin Publishing Company Inc., 1972, pages 124 to 154.

(Curable Composition)

The hydrophobic insulating film in the present invention is preferably prepared by using a curable composition which includes the polyfunctional compound.

One or two or more of the polyfunctional compounds may be incorporated in the curable composition.

The curable composition may further include a monofunctional compound.

The monofunctional compound is not particularly limited, and a known monofunctional monomer can be used. For example, as the monofunctional compound, a monofunctional monomer selected as appropriate from those exemplified above as the other monomers being allowed to undergo copolymerization can be used.

The content (in the case of using two or more kinds thereof, the total content; hereinafter, the same applies.) of the polyfunctional compound in the curable composition is not particularly limited. However, from the viewpoint of curability, the content of the polyfunctional compound is preferably 30% by mass or higher, more preferably 40% by mass or higher, and particularly preferably 50% by mass or higher, with respect to the total solids of the curable composition. Here, the term “total solids” refers to all components except solvent.

In a case in which the curable composition includes the polyfunctional compound represented by Formula (A) as the at least one polyfunctional compound, the content of the polyfunctional compound represented by Formula (A) is preferably 30% by mass or higher, more preferably 40% by mass or higher, and particularly preferably 50% by mass or higher, with respect to the total solids of the curable composition.

It is preferable that the curable composition further includes at least one solvent.

Examples of the solvent include ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, 1-butanol, propylene glycol monomethyl ether, propylene glycol monomethyl ether acetate, cyclohexanone, cyclohexanol, ethyl lactate, methyl lactate, and caprolactam.

The content (in the case of using two or more kinds thereof, the total content) of the solvent in the curable composition is preferably from 20% by mass to 90% by mass, more preferably from 30% by mass to 80% by mass, and particularly preferably from 40% by mass to 80% by mass, with respect to the total mass of the curable composition.

It is preferable that the curable composition further includes at least one polymerization initiator.

As the polymerization initiator, a polymerization initiator which generates a radical by the action of at least one of heat or light is preferable.

As the polymerization initiator that initiates radical polymerization by the action of heat, an organic or inorganic peroxide, an organic azo or diazo compound, or the like can be used.

Examples of the organic peroxide include benzoyl peroxide, halogenbenzoyl peroxide, lauroyl peroxide, acetyl peroxide, dibutyl peroxide, cumene hydroperoxide, and butyl hydroperoxide. Examples of the inorganic peroxide include hydrogen peroxide, ammonium peroxodisulfate, and potassium peroxodisulfate. Examples of the organic azo compound include 2-azo-bis-isobutyronitrile, 2-azo-bis-propionitrile, and 2-azo-bis-cyclohexane dinitrile. Examples of the diazo compound include diazoaminobenzene and p-nitrobenzene diazonium.

Examples of the polymerization initiator that initiates radical polymerization by the action of light include hydroxyalkylphenones, aminoalkylphenones, acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniums.

Examples of the hydroxyalkylphenones include 2-hydroxy-2-methyl-1-phenyl-1-propan-1-one, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 1-hydroxydimethyl phenyl ketone, and 1-hydroxycyclohexyl phenyl ketone.

Examples of the aminoalkylphenones include 2-dimethylamino-2-(4-methylbenzyl)-1-(4-morpholin-4-ylphenyl)butan-1-one, 2-benzyl-2-dimethylamino-1-(4-morpholinophenyl)-butanon-1, and 2-methyl-1-(4-methylthio phenyl)-2-morpholinopropan-1-one.

Examples of the acetophenones include 2,2-diethoxyacetophenone and p-dimethylacetophenone. Examples of the benzoins include benzoin benzenesulfonate, benzoin toluenesulfonate, benzoin methyl ether, benzoin ethyl ether, and benzoin isopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethylbenzoyldiphenylphosphine oxide.

Further, a sensitizing dye may be used in combination with the above polymerization initiator.

The content of the polymerization initiator is not particularly limited, but the content is preferably from 0.1% by mass to 15% by mass, more preferably from 0.5% by mass to 10% by mass, and particularly preferably from 2% by mass to 5% by mass, with respect to the total solids of the curable composition.

The curable composition may include one or more additional components, as necessary.

Examples of the additional components include inorganic oxide fine particles, a silicone based antifouling agent or a fluorine-containing antifouling agent, a slipping agent, a polymerization inhibitor, a silane coupling agent, a surfactant, a thickener, and a leveling agent.

The content of the additional component is preferably in a range of from 0% by mass to 30% by mass, more preferably in a range of from 0% by mass to 20% by mass, and particularly preferably in a range of from 0% by mass to 10% by mass, with respect to the total solids of the curable composition.

The film thickness of the hydrophobic insulating film in the present invention is not particularly limited, but is preferably from 50 nm to 10 μm, and more preferably from 100 nm to 1 μm. The film thickness of the hydrophobic insulating film being within the above range is preferable in view of the balance between the insulating property and the drive voltage.

(Method of Preparing Hydrophobic Insulating Film)

The hydrophobic insulating film in the present invention can be suitably prepared by a method which includes a curable layer forming process of forming a curable layer using the curable composition containing the polyfunctional compound at the side of the conductive surface of the first substrate (for example, in a case in which the first substrate has a conductive film, at least on the conductive film), and a curing process of curing the curable layer by polymerizing the polyfunctional compound in the curable layer formed. By this method, a hydrophobic insulating film having a crosslinking structure is prepared.

The formation of the curable layer on the first substrate can be carried out by a known coating method or transfer method.

In the case of the coating method, the curable composition is coated on the first substrate (and further, is preferably dried) to form a curable layer. The method of coating is not particularly limited and, for example, a know method such as a spin coating method, a slit coating method, a dip coating method, an air knife coating method, a curtain coating method, a roller coating method, a wire bar coating method, a gravure coating method, or an extrusion coating method can be used.

In the case of the transfer method, a transfer material having a curable layer which is formed by using the curable composition is prepared in advance, and the curable layer of the transfer material is transferred onto the first substrate, whereby a curable layer is formed on the first substrate. For the details on the transfer method, description in, for example, paragraphs 0094 to 0121 of JP-A No. 2008-202006 or paragraphs 0076 to 0090 of JP-A No. 2008-139378 can be referred to.

The curing of the curable layer (polymerization of the polyfunctional compound) can be carried out by, for example, at least one of irradiation (hereinafter, also referred to as “exposure”) with an actinic energy ray or heating.

The actinic energy ray used in the exposure is not particularly limited, and ultraviolet ray (g line, h line, i line, or the like), electron beam, or X-ray is preferably used. The exposure may be conducted by using a known exposure device of a proximity system, a mirror projection system, a stepper system, or the like.

The exposure value in the exposure can be set appropriately but, the exposure value may be, for example, from 10 mJ/cm² to 2000 mJ/cm², and is preferably from 50 mJ/cm² to 1000 mJ/cm².

Further, by exposing through a prescribed photomask in the above exposure and subsequently developing using a developing solution such as an alkali solution, it is possible to obtain a hydrophobic insulating film which is patterned in a desired pattern.

The heating can be carried out by a known method using, for example, a hot plate or an oven.

The heating temperature can be set appropriately but, the heating temperature may be, for example, from 100° C. to 280° C., and is preferably from 150° C. to 250° C. The heating time can also be set appropriately but, the heating time may be, for example, from 2 minutes to 120 minutes, and is preferably from 5 minutes to 60 minutes.

<First Substrate and Second Substrate>

The first substrate in the present invention is a substrate, at least a portion of at least one surface of which has conductivity.

The second substrate in the present invention is a substrate which is arranged so as to face the conductive surface of the first substrate.

From the viewpoint of using the optical element of the present invention in an image display device or a variable focal length lens, it is preferable that at least one of the first substrate or the second substrate has light transmitting property, and specifically, the light transmittance is preferably 80% or higher (more preferably, 90% or higher) over the entire wavelength region of from 380 nm to 770 nm. The light transmittance can be measured according to, for example, JIS K 7361-1.

(First Substrate)

The first substrate is not particularly limited as long as at least a portion of at least one surface thereof has conductivity. This conductive surface functions as the electrode in the optical element.

Here, the term “conductivity” is not particularly limited as long as the term indicates the property of being the extent of being able to apply a voltage, and, for example, the property of the surface resistance of 500Ω/□ or less (preferably 70Ω/□ or less, more preferably 60Ω/□ or less, and even more preferably 50Ω/□ or less) is preferable.

The first substrate may be a singularly constituted conductive substrate (a metal substrate or the like) or may be a substrate constituted to have a supporting substrate and a conductive film (which may be a conductive film that has been subjected to patterning, or may be a conductive film that has not been subjected to patterning) provided on the supporting substrate.

Among them, from the viewpoint of using the optical element of the present invention in an image display device or a variable focal length lens, it is preferable that the first substrate is constituted to have a supporting substrate and a conductive film provided on the supporting substrate. In this form, the conductive surface in the first substrate corresponds to the surface of the conductive film. The surface resistance can be measured according to, for example, JISC 2139.

As the supporting substrate, a glass substrate (for example, a non-alkali glass substrate, a soda glass substrate, a PYREX (registered trademark) glass substrate, a quartz glass substrate, or the like), a plastic substrate (for example, a polyethylene naphthalate (PEN) substrate, a polyethylene terephthalate (PET) substrate, a polycarbonate (PC) substrate, a polyimide (PI) substrate, or the like), a metal substrate such as an aluminum substrate or a stainless steel substrate, a semiconductor substrate such as a silicone substrate, or the like can be used. Among them, from the viewpoint of light transmitting property, a glass substrate or a plastic substrate is preferable.

Further, as the supporting substrate, a TFT substrate provided with a thin film transistor (TFT) can also be used. In this case, a form in which the conductive film described above is connected to the TFT (namely, a form in which the conductive film is a pixel electrode that is connected to the TFT) is preferable. By having this form, a voltage can be applied individually to every pixel and thus, it becomes possible to realize active driving of the entire image display device, similar to the case of a known liquid crystal display device equipped with a TFT.

The arrangement of the TFT, various wirings, a storage capacity, and the like in the above TFT substrate may be a known arrangement. For example, the arrangement described in JP-A No. 2009-86668 can be referred to.

The specific resistance of the conductive film is not particularly limited but, for example, the specific resistance may be 1.0×10³ Ω·cm or less.

As the conductive film, a metal film may also be used but, from the viewpoint of light transmitting property, a transparent conductive film is preferable.

The transparent conductive film preferably has a light transmittance of 80% or higher (more preferably, 90% or higher) over the entire wavelength region of from 380 nm to 770 nm.

Examples of the transparent conductive film include films containing at least one of indium tin oxide (which is also referred to as ITO), indium zinc oxide (which is also referred to as IZO), tin oxide, indium oxide, zirconium oxide, zinc oxide, cadmium oxide, or magnesium oxide.

Among them, as the transparent conductive film, a film containing indium tin oxide (ITO) is preferable, from the viewpoints of the light transmitting property and conductivity.

The addition amount of tin oxide in the film containing indium tin oxide (ITO) is preferably in a range of from 5% by mass to 15% by mass, from the viewpoint of reducing the resistance value, and more preferably from 8% by mass to 12% by mass.

(Second Substrate)

The second substrate is not particularly limited and, for example, a substrate exemplified above as the supporting substrate can be used.

Further, as the second substrate, similar to the first substrate, a substrate, at least a portion of at least one surface of which has conductivity, can be also used, and in this case, a preferable form of the second substrate is the same as the preferable form of the first substrate.

In a form in which the second substrate has a conductive film, the conductive film functions, for example, as the electrode for applying a voltage to the hydrophilic liquid.

A particularly preferable form in the case of using the optical element of the present invention as a pixel of an image display device is a form in which an independent voltage is applied to each pixel by applying an independent voltage to every pixel in the surface of the conductive film of the first substrate, while applying a common voltage over plural pixels to the conductive film of the second substrate. For this form, the form of a known liquid crystal display device can be referred to.

<Oil>

The oil in the present invention is a non-conductive oil.

The oil may be an oil of a single component, or may be an oil (an oil composition) including two or more components.

Here, the term “non-conductive” is not particularly limited, but refers to the property of, for example, the specific resistance of 10⁶ Ω·cm or more (preferably, 10⁷ Ω·cm or more).

Further, it is preferable that the oil has a low dielectric constant.

Specifically, the dielectric constant of the oil is preferably in a range of 10.0 or less, and more preferably in a range of from 2.0 to 10.0. The dielectric constant being within this range is preferable in that the response speed is faster and driving (action) can be conducted at a lower voltage, as compared with the case in which the dielectric constant exceeds 10.0.

Here, the dielectric constant is a value obtained by injecting the oil into a glass cell, which is equipped with an ITO transparent electrode and has a cell gap of 10 μm, and measuring the electric capacity of the cell thus obtained by using a model 2353 LCR meter (measuring frequency: 1 kHz), manufactured by NF Corporation, at 20° C. and 40% RH.

Further, it is preferable that the viscosity of the oil is 10 mPa·s or less, in terms of dynamic viscosity at 20° C. Above all, the viscosity is preferably 0.01 mPa·s or more, and more preferably from 0.01 mPa·s to 8 mPa·s. The viscosity of the oil being 10 mPa·s or less is preferable in that the response speed is faster and driving (action) can be conducted at a lower voltage, as compared with the case in which the viscosity exceeds 10 mPa·s.

Note that, the dynamic viscosity is a value measured by using a viscometer (model 500, manufactured by Toki Sangyo Co., Ltd.) under the condition of 20° C.

It is preferable that the oil does not substantially mix with the hydrophilic liquid described below.

Specifically, the solubility (at 25° C.) of the oil with respect to the hydrophilic liquid is preferably 0.1% by mass or lower, more preferably 0.01% by mass or lower, and particularly preferably 0.001% by mass or lower.

It is preferable that the oil contains at least one nonpolar solvent as the solvent. Here, the term “nonpolar solvent” refers to a solvent that has a low dielectric constant value (a so-called an apolor solvent).

Examples of the nonpolar solvent include an aliphatic hydrocarbon solvent (preferably, an aliphatic hydrocarbon solvent having from 6 to 30 carbon atoms), for example, n-hexane, n-decane, dodecane, tetradecane, hexadecane, or the like; a solvent obtained by substituting the above aliphatic hydrocarbon solvent with fluorine (for example, fluorocarbon oil or the like); and a silicone-containing solvent (for example, silicone oil or the like). Among them, an aliphatic hydrocarbon solvent is preferable.

The content of the nonpolar solvent is preferably 70% by mass or higher, and more preferably 90% by mass or higher, with respect to the total mass of the solvent included in the oil. When the content of the nonpolar solvent is 70% by mass or higher, more excellent optical shutter characteristics can be realized. Further, in a case in which the oil contains a coloring material, the solubility of the coloring material in the oil may be maintained more satisfactorily.

(Coloring Material)

For example, in a case in which the optical element of the present invention is used as a pixel of an image display device, it is preferably that the oil contains at least one coloring material.

The coloring material is not particularly limited, and can be arbitrary selected from dyes having solubility or dispersibility with respect to the nonpolar solvent, as long as the effects of the present invention are not impaired.

As the coloring material, a dye or pigment that exhibits solubility with respect to the nonpolar solvent is preferable, and a dye is more preferable.

The coloring material is not particularly limited but, for example, a dye that dissolves in a nonpolar solvent can be appropriately selected to be used from dyes known in the field of color filters for image display devices (for example, color filters for liquid crystal display devices, color filters for solid state imaging elements, or the like).

Examples of the dyes may include various dyes such as a methine dye (for example, a pyrazolone methine dye, a pyridone methine dye, an isooxazolone methine dye, an isooxazoline methine dye, or the like), an azomethine dye (for example, a pyrazolone azomethine dye, a pyridone azomethine dye, an isooxazolone azomethine dye, a pyrrolotriazole azomethine dye, a pyrazolonetriazole azomethine dye, a naphthol azomethine dye, or the like), an azo dye (for example, a monoazo dye, a bisazo dye, a benzothiazolyl monoazo dye, a pyrazole azo dye, an anilino azo dye, a pyrazolotriazole azo dye, or a pyridone azo dye), a dipyrromethene dye, an anthraquinone dye, a triphenylmethane dye, an anthrapyridone dye, a benzylidene dye, an oxonol dye, a cyanine dye, a phenothiazine dye, a xanthene dye, a phthalocyanine dye, a benzopyrane dye, or an indigo dye.

More specifically, examples of the dye include Oil Blue N (alkylamine substituted anthraquinone), Solvent Green, Sudan Red, and Sudan Black.

Further, as the coloring material, coloring materials described in International Publication WO 2011/111710, International Publication WO 2008/142086, and JP-A No. 2009-138189 can also be used preferably.

The dyes can be synthesized according to known methods.

For example, synthesis of the azomethine dye can be performed in accordance with a method described in Journal of the American Chemical Society (J. Am. Chem. Soc.), 1957, vol. 79, page 583, JP-A Nos. 9-100417, 2011-116898, 2011-12231, 2010-260941, and 2007-262165, and the like.

Synthesis of the pyrazolone methine dye can be performed in accordance with a method described, for example, in JP-A Nos. 2008-248123, 2-3450, and 49-114420, Japanese Patent No. 2707371, JP-A Nos. 5-45789, 2009-263517, and 3-72340, and the like.

Synthesis of the isooxazolone methine dye can be performed in accordance with a method described, for example, in Japanese Patent No. 2707371, JP-A Nos. 5-45789, 2009-263517, and 3-72340, and the like.

Synthesis of the monoazo dye, bisazo dye, or anthraquinone dye can be performed in accordance with a method described, for example, in Yutaka Hosoda, “Shin Senryo Kagaku (New Dye Chemical)” (published on Dec. 21, 1973, Gihodo Shuppan., Ltd.), A. V. Ivashchenko, Dichroic Dyes for Liquid Crystal Displays, CRC Press, 1994, Bulletin of the Chemical Society of Japan, vol. 76, pages 607 to 612, 2003, Bulletin of the Chemical Society of Japan, vol. 72, pages 127 to 132, 1999, and the like.

Synthesis of the dipyrromethene dye can be performed in accordance with a method described, for example, in JP-A No. 2008-292970.

Further, the azo dye can be produced by a known method shown in Japanese Patent Nos. 4408380, 4642403, 4357383, and 4359541, JP-A Nos. 2006-91190, 2007-31616, and 2007-39478, Japanese Patent No. 4597806, JP-A No. 2002-371079, Japanese Patent No. 4666873, and the like.

One of the coloring materials may be used alone, or two or more of them may be used in combination.

In a case in which the oil contains a coloring material, the content of the coloring material is not particularly limited, and those with any concentration can be prepared according the intended use.

The content of the coloring material may be, for example, 0.2% by mass or higher, with respect to the total mass of the oil, and the coloring material is used by diluting with a solvent (for example, a nonpolar solvent) according to the ∈C value needed (8 represents the absorption coefficient of the oil).

From the viewpoint of the hue or the color density, the content of the coloring material is preferably 20% by mass or higher, more preferably 30% by mass or higher, even more preferably 40% by mass or higher, and particularly preferably 50% by mass or higher, with respect to the total mass of the oil.

The oil may contain various additives such as an ultraviolet absorbent or an antioxidant, as necessary. The content of the additive is not particularly limited, but generally, the additive is used in an amount of about 20% by mass or less with respect to the total mass of the oil.

<Hydrophilic Liquid>

The hydrophilic liquid in the present invention is a conductive hydrophilic liquid.

Here, the term “conductive” is not particularly limited, but refers to the property of, for example, the specific resistance of 10⁵ Ω·cm or less (preferably, 10⁴ Ω·cm or less).

The hydrophilic liquid contains, for example, an electrolyte and an aqueous solvent.

Examples of the electrolyte include salts such as sodium chloride, potassium chloride, or tetrabutylammonium chloride.

The concentration of the electrolyte in the hydrophilic liquid is preferably from 0.1 mol/L to 10 mol/L, and more preferably from 0.1 mol/L to 5 mol/L.

Further, the hydrophilic liquid may include an aqueous solvent other than water, as the aqueous solvent. Examples of the aqueous solvent other than water include alcohol-based solvents such as ethanol.

<Additional Member>

The optical element of the present invention preferably has a partition that decides the cell region, on the first substrate. As described above, this partition may be in contact with the second substrate or may be not in contact with the second substrate.

The partition preferably contains a resin and, for example, the partition may have the same configuration as that of a known partition used in an image display device such as a liquid crystal display device.

The partition may be formed, for example, according to a known photolithography process using a photosensitive resist or a photosensitive film.

The optical element of the present invention may further have, as necessary, one or more additional members such as a voltage application means (for example, a power supply) for applying a voltage between the hydrophilic liquid and the conductive surface of the first substrate or a spacer for ensuring the cell gap (the distance between the surface of the hydrophobic insulating film provided on the first substrate and the second substrate). As the additional member that may be used in the optical element of the present invention, for example, a known member used in the image display device such as a liquid crystal display device can be used.

Note that, the cell gap (the distance between the surface of the hydrophobic insulating film which is provided on the first substrate and the second substrate) of the cell in the present invention is not particularly limited, but the cell gap can be set appropriately, for example, to a value in a range of from 3 μm to 100 μm.

Further, the cell area of the cell in the present invention is preferably in a range of from 100 μm² to 100 cm², more preferably in a range of from 500 μm² to 10 cm², and particularly preferably in a range of from 1000 μm² to 1 cm².

Moreover, it is preferable that the cell in the present invention is filled with oil and a hydrophilic liquid. The volume ratio of the oil and the hydrophilic liquid (oil:hydrophilic liquid) is preferably from 1:1000 to 1:0.1, more preferably from 1:100 to 1:1, and particularly preferably from 1:50 to 1:2.

<<Image Display Device>>

The image display device of the present invention is equipped with a pixel which has the above-described optical element of the present invention, and the oil contains a coloring material.

Since the image display device of the present invention is equipped with a pixel which has the above-described optical element of the present invention, deterioration of the hydrophobic insulating film when the voltage is repeatedly switched on and off is suppressed, and thus, the image display device of the present invention exhibits excellent durability during repeated driving.

A preferable form of the image display device of the present invention is as described above.

More specifically, the image display device of the present invention may replace the liquid crystal in a configuration of a known liquid crystal display device with oil and a hydrophilic liquid. Accordingly, the image display device of the present invention can be driven in a similar manner to that in the conventional liquid crystal display device.

Namely, the image display device of the present invention may be constituted to have, as necessary, the same member as the member of a known liquid crystal display device, such as a back light, a spacer for adjusting the cell gap, or a sealant for sealing, in addition to the pixel including the optical element of the present invention.

In this process, for example, the oil and the hydrophilic liquid can be applied to the region divided by the partition on the first substrate in accordance with an inkjet method.

Concerning a method of producing the image display device of the present invention, for example, a method may be described, which includes a first substrate preparing process of preparing the first substrate described above; a process of forming the hydrophobic insulating film described above on the side of the conductive surface of the first substrate; a partition forming process of forming a partition that divides the face formed with the hydrophobic insulating film of the first substrate; an application process of applying (for example, by an inkjet method) the oil and the hydrophilic liquid in this order to the region divided by the partition; and a cell forming process of placing the second substrate on a side of the first substrate after the application process, the side having been applied with the oil and the hydrophilic liquid, to form a cell; (and further, as needs arise, a sealing process of sealing the cell by adhering the first substrate and the second substrate at the circumference of the cell.)

The adhesion of the first substrate and the second substrate can be conducted by using a sealant which is generally used in the preparation of liquid crystal display devices.

Further, a spacer forming process of forming a spacer for adjusting the cell gap may be provided, after the partition forming process but before the cell forming process.

### EXAMPLES

Hereinafter, the present invention is specifically described with reference to Examples; however, the invention is by no means limited to the following Examples unless they are beyond the spirit of the invention. Unless otherwise specifically stated, the “parts” and “%” are based on mass.

### Examples 1 to 20

### Preparation of Curable Compositions A1 to A20

A polymerizable monomer and a polymerization initiator, the kind and amount of which are shown in the following Table 1 and Table 2, were dissolved in methyl ethyl ketone to prepare a solution having a concentration of solids of 30% by mass. Thereafter, as a polymerization inhibitor, 4-hydroxy-2,2,6,6-tetramethylpiperidin-1-oxyl free radical (manufactured by Tokyo Chemical Industry Co., Ltd.) was added such that the amount thereof was 200 ppm (0.02% by mass) with respect to the polymerizable monomer. The obtained solution was filtrated using a 0.1 μm filter made of tetrafluoroethylene, thereby preparing curable compositions A1 to A20, respectively.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|---|---|---|---|
| Curable Composition | | A1 | A2 | A3 | A4 | A5 | A6 | A7 | A8 | A9 | A10 | A11 | A12 |
| Polymerization | M-1 | 97 | none | none | none | none | none | none | none | none | none | none | none |
| Monomer | M-2 | none | 60 | none | none | none | none | none | none | none | none | none | none |
| | M-3 | none | none | 60 | none | none | none | none | none | none | none | none | none |
| | M-4 | none | none | none | 50 | none | none | none | none | none | none | none | none |
| | M-9 | none | none | none | none | 50 | 50 | 70 | none | none | none | none | none |
| | M-10 | none | none | none | none | none | none | none | 50 | none | none | none | none |
| | M-14 | none | none | none | none | none | none | none | none | 50 | none | none | none |
| | M-15 | none | none | none | none | none | none | none | none | none | 50 | none | none |
| | M-16 | none | none | none | none | none | none | none | none | none | none | 70 | none |
| | M-17 | none | 37 | none | none | none | 47 | none | none | none | none | 27 | none |
| | M-18 | none | none | 37 | none | none | none | none | none | none | none | none | none |
| | M-19 | none | none | none | 47 | none | none | none | 47 | none | none | none | none |
| | M-20 | none | none | none | none | none | none | none | none | none | none | none | none |
| | M-21 | none | none | none | none | 47 | none | none | none | none | 47 | none | none |
| | M-22 | none | none | none | none | none | none | none | none | none | none | none | 70 |
| | M-23 | none | none | none | none | none | none | 27 | none | 47 | none | none | 27 |
| Initiator | P-1 | 3 | 3 | 3 | none | none | none | 3 | 3 | 3 | none | none | none |
| | P-2 | none | none | none | 3 | 3 | 3 | none | none | none | 3 | 3 | 3 |

TABLE 2

| | | Ex. 13 | Ex. 14 | Ex. 15 | Ex. 16 | Ex. 17 | Ex. 18 | Ex. 19 | Ex. 20 |
|---|---|---|---|---|---|---|---|---|---|
| Curable Composition | | A13 | A14 | A15 | A16 | A17 | A18 | A19 | A20 |
| Polymerizable | M-24 | 60 | none | none | none | none | none | none | none |
| Monomer | M-25 | none | 60 | none | none | none | none | none | none |
| | M-27 | none | none | 60 | none | none | none | none | none |
| | M-31 | none | none | none | 60 | none | none | none | none |
| | M-54 | none | none | none | none | 60 | none | none | none |
| | M-63 | none | none | none | none | none | 60 | none | none |
| | M-64 | none | none | none | none | none | none | 60 | none |
| | M-74 | none | none | none | none | none | none | none | 60 |
| | M-17 | 37 | 37 | 37 | 37 | 37 | 37 | 37 | 37 |
| Initiator | P-1 | 3 | 3 | 3 | 3 | 3 | 3 | 3 | 3 |

(Explanation of Table 1 and Table 2)
The numeric value of each component shown in Table 1 and Table 2 indicates a mass ratio.
Details on the polymerizable monomers and initiators shown in Table 1 and Table 2 are as follows.
The abbreviation “Ex.” denotes “Example Number”.

—Polymerizable Monomer—

M-1 to M-4, M-9, M-10, M-24, M-25, M-27, M-31, M-54, M-63, M-64 and M-74: the above exemplified compounds M-1 to M-4, M-9, M-10, M-24, M-25, M-27, M-31, M-54, M-63, M-64 and M-74 (all polyfunctional compounds)

M-14: dipentaerythritol hexaacrylate (trade name: KAYARAD DPHA, manufactured by Nippon Kayaku Co., Ltd.) (polyfunctional compound)

M-15: tetrafunctional urethane acrylate (trade name: U-4HA, manufactured by Nippon Kayaku Co., Ltd.) (polyfunctional compound)

M-16: pentaerythritol tetraacrylate (trade name: ATMMT, manufactured by Shin-Nakamura Chemical Co., Ltd.) (polyfunctional compound)

M-17: 2,2,2-tetrafluoroethyl acrylate (trade name: V-3F, manufactured by Osaka Organic Chemical Industry Co., Ltd.) (monofunctional compound)

M-18: 2-(perfluorobutyl)ethyl acrylate (trade name: R-1420, manufactured by Daikin Industries, Ltd.) (monofunctional compound)

M-19: 2,2,3,3,4,4,5,5-octafluoro-1,6-hexane diacrylate (manufactured by SynQuest Laboratories, Inc.) (polyfunctional compound)

M-20: tricyclodecanedimethanol diacrylate (trade name: A-DCP, manufactured by Shin-Nakamura Chemical Co., Ltd.) (polyfunctional compound)

M-21: stearyl acrylate (manufactured by Tokyo Chemical Industry Co., Ltd.) (monofunctional compound)

M-22: ethoxylated isocyanuric acid triacrylate (trade name: A-9300, manufactured by Shin-Nakamura Chemical Co., Ltd.) (polyfunctional compound)

M-23: ethylene glycol diacrylate (manufactured by Sigma-Aldrich Corporation) (polyfunctional compound)

—Initiator (Photopolymerization Initiator)—

P-1: 2-hydroxy-2-methyl-1-phenyl-1-propan-1-one (trade name: DAROCUR 1173, manufactured by BASF)

P-2: 2-(dimethylamino)-2-(4-methylbenzyl)-1-(4-morpholin-4-ylphenyl)butan-1-one (trade name: IRGACURE 379EG, manufactured by BASF)

<Preparation of Oil>

The components in the following formulation were mixed, to obtain oil.

The oil thus obtained was black, and the dynamic viscosity thereof (at 20° C.) obtained by the measurement using a viscometer was 7.9 mPa·s.

Hereinafter, the oil may also be referred to as the “black ink”.

—Formulation of Oil (Black Ink)—

| | |
|---|---|
| Dye Y1 described below | 260 mg |
| Dye M1 described below | 200 mg |
| Dye M2 described below | 160 mg |
| Dye Cl described below | 300 mg |
| Dye C2 described below | 100 mg |
| n-Decane | 4080 mg |

Dye Y1 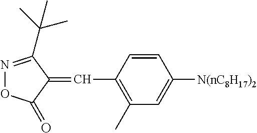
Dye M1 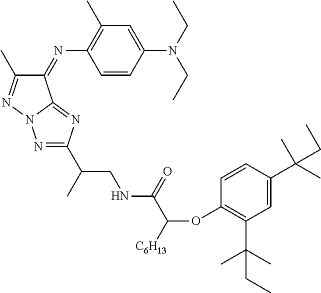
Dye M2 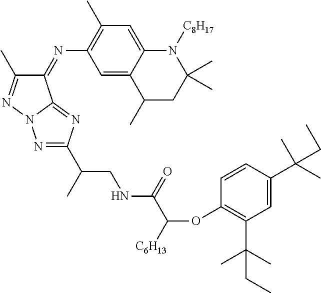
Dye C1 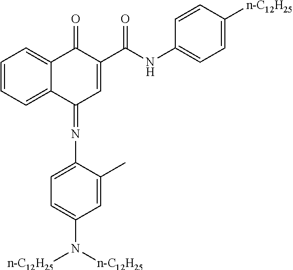
Dye C2

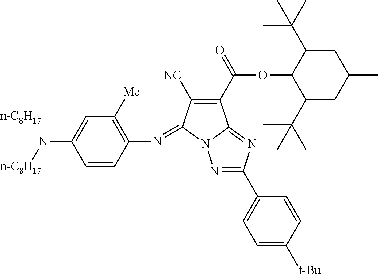

<Preparation of Test Cell>

An optical element (test cell 300) having a structure shown in FIG. 4 was prepared as follows.

FIG. 4 is a schematic sectional view of a test cell used in the example.

First, as the first substrate 211, a glass substrate 211a (1 cm square) having thereon an indium tin oxide film (an ITO film; a transparent electrode) 211b with a film thickness of 100 nm was prepared.

On the ITO film 211b of this glass substrate 211a, any one of the curable compositions A1 to A 20 obtained as described above was coated, to form a coated layer. Subsequently, a portion of the solvent was dried for 30 seconds using a VCD (vacuum drying apparatus, manufactured by Tokyo Ohka Kogyo Co., Ltd.) so as to eliminate the fluidity of the coated layer, and then, a prebaking treatment was carried out at 120° C. for 3 minutes, thereby obtaining a curable composition layer. With regard to the curable composition layer thus obtained, under a nitrogen atmosphere, exposure was performed using an ultrahigh pressure mercury lamp at an exposure value of 300 mJ/cm², thereby polymerizing the polyfunctional compound contained in the curable composition layer, to cure the curable composition layer. Further, with regard to the curable composition layer that had been exposed to light, a heat treatment was performed at 240° C. for 50 minutes.

In this way, a hydrophobic insulating film 220 (a crosslinked film; film thickness: 100 nm) having a crosslinking structure derived from the polyfunctional compound was formed on the ITO film 211b.

A photoresist film (trade name: PHOTOCAST, manufactured by Hitachi Chemical Co., Ltd.) having a thickness of 20 μm was placed on the thus formed hydrophobic insulating film 220, and then the photoresist film was exposed to light through a photomask having a lattice-like pattern (the size of the lattice: 200 μm square, line with of the lattice: 20 μm), followed by carrying out an alkali development treatment, thereby preparing a partition 223 (height: 20 μm, width: 20 μm).

As the sealant 232, silicone rubber (trade name: SILI-US, manufactured by Fuso Rubber Co., Ltd.) having a thickness of 40 μm and a width of 1 mm was placed at the edge of the glass substrate on which the partition had been formed.

Next, as the oil 216, the oil (black ink) obtained as described above was poured, by an inkjet method, into the region divided by the partition 223 so that the thickness became 4 μm and then, on the oil, an electrolysis solution (an aqueous solution of NaCl having an NaCl concentration of 1 mol/L) as the hydrophilic liquid 214 was poured so that the thickness became 36 μm.

On this assembly, a glass substrate 212a provided with an ITO film 212b (the second substrate 212) was placed such that the ITO film 212b was arranged on the side of the hydrophilic liquid 214 (electrolysis solution), and the first substrate 211 provided with the hydrophobic insulating film 220 and the second substrate 212 were fixed by using silicone rubber (sealant 232).

In this way, the test cell 300 shown in FIG. 4 was prepared.

<Evaluation of Durability During Driving>

In the test cell 300 obtained as described above, when the voltage was not applied (voltage off state), the black ink (oil 216) spread over the hydrophobic insulating film 220, and the test cell was black (FIG. 4).

When the transparent electrodes (ITO film 212b and ITO film 211b) on the upper and lower sides of this test cell 300 were each connected to a signal generator and a direct voltage of 15 V was applied (voltage on state), it was confirmed that the black ink (oil 216) shrank and the test cell became transparent (not shown in the figure).

Next, when the application of the direct voltage was stopped (to be in the voltage off state), the black ink (oil 216) spread again over the hydrophobic insulating film 220, and the test cell became black.

The above voltage on and voltage off cycle (direct voltage application time: 30 seconds, interval (voltage non-application time): 30 seconds) was repeatedly performed for 500 times.

Further, after repeatedly performing this cycle for 500 times, the test cell was made to be in the voltage on state, to let the black ink (oil 216) shrink. This state was visually observed, and evaluated according to the following evaluation criteria.

The evaluation results are shown in Table 3 below.

—Criteria for Evaluation of Durability—

A: The degree of shrinkage of the black ink after repeatedly performing the above cycle for 500 times is the same as the degree of shrinkage of the black ink in the first cycle.

B: The degree of shrinkage of the black ink after repeatedly performing the above cycle for 500 times is a bit smaller than the degree of shrinkage of the black ink in the first cycle.

C: After repeatedly performing the above cycle for 500 times, the black ink hardly shrinks, and by repeatedly performing the above cycle for 500 times, the responsiveness with respect to the application of a voltage is considerably deteriorated.

### Comparative Example 1

Preparation of a test cell was conducted in a manner substantially similar to that in Example 1, except that the hydrophobic insulating film prepared by using the curable composition A1 in the preparation of the test cell of Example 1 was changed to a hydrophobic insulating film prepared by using Teflon (registered trademark) AF-1600 (trade name, manufactured by E.I. du Pont de Nemours and Company). Evaluation was performed in a manner substantially similar to that in Example 1. Here, AF-1600 is an amorphous fluoropolymer that does not have a crosslinking structure.

The evaluation results are shown in Table 3 below.

### Comparative Example 2

Preparation of a test cell was conducted in a manner substantially similar to that in Example 1, except that the hydrophobic insulating film 220 prepared by using the curable composition A1 in the preparation of the test cell of Example 1 was changed to a hydrophobic insulating film prepared by using CYTOP “CTL-809M” (trade name, manufactured by ASAHI GLASS CO., LTD.). Evaluation was performed in a manner substantially similar to that in Example 1. Here, CYTOP is an amorphous fluoropolymer that does not have a crosslinking structure. The evaluation results are shown in Table 3 below.

TABLE 3

| | Material of Hydrophobic | |
|---|---|---|
| | Insulating Film | Durability |
| Example 1 | Curable Composition A1 | A |
| Example 2 | Curable Composition A2 | A |
| Example 3 | Curable Composition A3 | A |
| Example 4 | Curable Composition A4 | A |
| Example 5 | Curable Composition A5 | A |
| Example 6 | Curable Composition A6 | A |
| Example 7 | Curable Composition A7 | A |
| Example 8 | Curable Composition A8 | A |
| Example 9 | Curable Composition A9 | B |
| Example 10 | Curable Composition A10 | B |
| Example 11 | Curable Composition A11 | B |
| Example 12 | Curable Composition A12 | B |
| Example 13 | Curable Composition A13 | A |
| Example 14 | Curable Composition A14 | A |
| Example 15 | Curable Composition A15 | A |
| Example 16 | Curable Composition A16 | A |
| Example 17 | Curable Composition A17 | A |
| Example 18 | Curable Composition A18 | A |
| Example 19 | Curable Composition A19 | A |
| Example 20 | Curable Composition A20 | A |
| Comparative Example 1 | AF-1600 | C |
| Comparative Example 2 | CYTOP | C |

As shown in Table 3, the test cells of Examples 1 to 20, in which the hydrophobic insulating film having a crosslinking structure derived from a polyfunctional compound was used, exhibited excellent durability with respect to repeated driving, as compared with the test cells of Comparative Examples 1 and 2, in which a hydrophobic insulating film that does not have a crosslinking structure was used.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

This application claims priority from Japanese Patent Application Nos. 2012-082545, filed Mar. 30, 2012, and 2013-043478, filed Mar. 5, 2013, which are incorporated herein by reference. All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An optical element comprising a cell, the cell comprising:
a first substrate, at least a portion of at least one surface of which has conductivity;
a second substrate which is arranged so as to face the conductive surface of the first substrate;
a non-conductive oil and a conductive hydrophilic liquid that are provided between the conductive surface of the first substrate and the second substrate; and
a hydrophobic insulating film that is provided at least at a portion on the conductive surface side of the first substrate, that contacts the non-conductive oil, and that has a crosslinking structure derived from a polyfunctional compound having two or more polymerizable groups,
wherein a shape of an interface between the non-conductive oil and the hydrophilic liquid changes according to a voltage applied between the hydrophilic liquid and the conductive surface of the first substrate.

2. The optical element according to claim 1, wherein a contact area between the non-conductive oil and the hydrophobic insulating film changes according to the voltage.

3. The optical element according to claim 1, wherein the polyfunctional compound is a fluorine-containing compound.

4. The optical element according to claim 3, wherein the polyfunctional compound is a fluorine-containing compound, in which a fluorine content is 30% by mass or more based on molecular weight.

5. The optical element according to claim 1, wherein the polyfunctional compound has three or more polymerizable groups.

6. The optical element according to claim 1, wherein the hydrophobic insulating film has been prepared by curing a curable composition containing the polyfunctional compound, and has a crosslinking structure formed by polymerization of the polyfunctional compound.

7. The optical element according to claim 1, wherein the polyfunctional compound is represented by the following Formula (A): 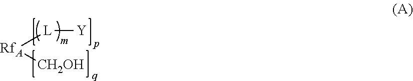
wherein, in Formula (A), Rf_{A} represents a (p+q)-valent linear or cyclic linking group containing a carbon atom and a fluorine atom; L represents a divalent linking group of an alkylene group having from 1 to 10 carbon atoms, an arylene group having from 6 to 10 carbon atoms, —O—, —S—, —N(R)—, or a group obtained by a combination of an alkylene group having from 1 to 10 carbon atoms and at least one of —O—, —S—, or —N(R)—; R represents a hydrogen atom or an alkyl group having from 1 to 5 carbon atoms; Y represents a polymerizable group selected from the group consisting of a (meth)acryloyl group, an allyl group, an alkoxysilyl group, an α-fluoroacryloyl group, an epoxy group and —C(O)OCH═CH₂; p represents an integer of 3 to 10; q represents an integer of 0 to 7; (p+q) is an integer of 3 to 10; and m represents 0 or 1.

8. The optical element according to claim 1, wherein the polyfunctional compound is represented by the following Formula (B): 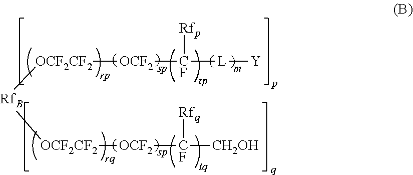
wherein, in Formula (B), Rf_{B} represents a (p+q)-valent linear or cyclic saturated perfluorohydrocarbon group or a (p+q)-valent linear or cyclic linking group obtained by a combination of a saturated perfluorohydrocarbon group and —O—; each of Rfₚ and Rf_{q} independently represents a monovalent linear or cyclic group containing a carbon atom and a fluorine atom; L represents a divalent linking group of an alkylene group having from 1 to 10 carbon atoms, an arylene group having from 6 to 10 carbon atoms, —O—, —S—, —N(R)—, or a group obtained by a combination of an alkylene group having from 1 to 10 carbon atoms and at least one of —O—, —S—, or —N(R)—; R represents a hydrogen atom or an alkyl group having from 1 to 5 carbon atoms; Y represents a polymerizable group selected from the group consisting of a (meth)acryloyl group, an allyl group, an alkoxysilyl group, an α-fluoroacryloyl group, an epoxy group and —C(O)OCH═CH₂; p represents an integer of 3 to 10; q represents an integer of 0 to 7; (p+q) is an integer of 3 to 10; m represents 0 or 1; each of rp and rq independently represents an integer of 0 to 100; each of sp and sq independently represents 0 or 1; and each of tp and tq independently represents 0 or 1.

9. The optical element according to claim 1, wherein the polyfunctional compound is represented by the following Formula (1):
RfLₘY]ₙ (1)
wherein, in Formula (1), Rf represents an n-valent group selected from the group consisting of the following Formulae (f-1) to (f-9); L represents a divalent linking group of an alkylene group having from 1 to 10 carbon atoms, an arylene group having from 6 to 10 carbon atoms, —O—, —S—, —N(R)—, or a group obtained by a combination of an alkylene group having from 1 to 10 carbon atoms and at least one of —O—, —S—, or —N(R)—; R represents a hydrogen atom or an alkyl group having from 1 to 5 carbon atoms; Y represents a polymerizable group selected from the group consisting of a (meth)acryloyl group, an allyl group, an alkoxysilyl group, an α-fluoroacryloyl group, an epoxy group and —C(O)OCH═CH₂; n represents an integer of 3 to 6; and m represents 0 or 1, and wherein, in Formulae (f-1) to (f-9), in a case in which m represents 1, * represents a bonding site to bond to L; and in a case in which m represents 0, * represents a bonding site to bond to Y:

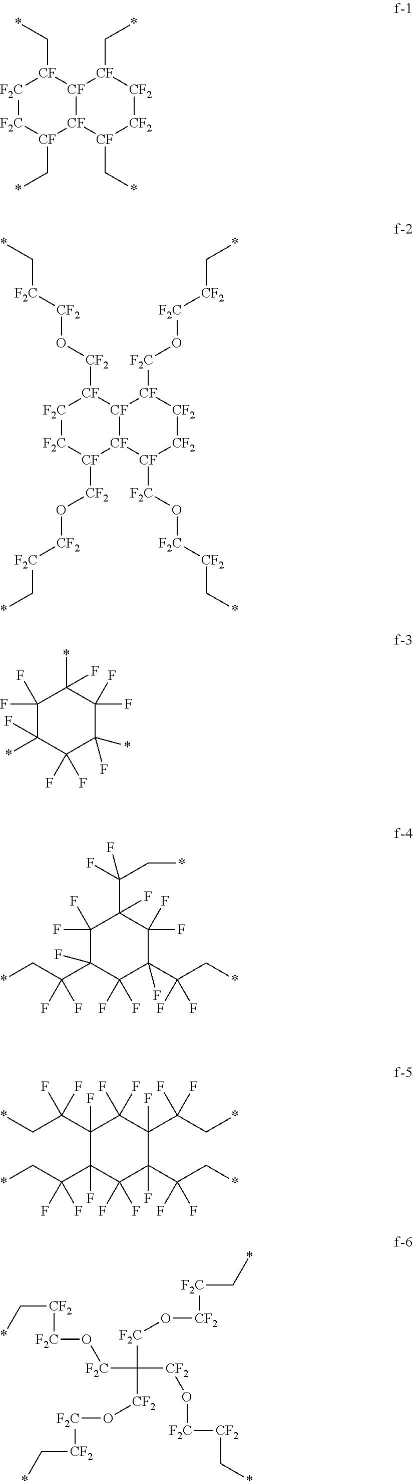

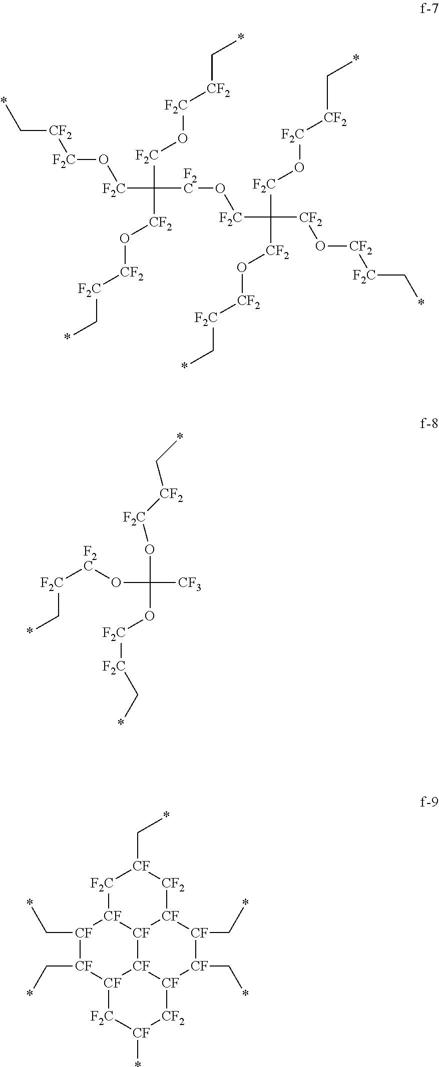

10. The optical element according to claim 1, wherein the polyfunctional compound is a fluorine-containing compound, in which all calculated values for molecular weight between crosslinkings are respectively 300 or less, when polymerization is performed using the two or more polymerizable groups in the polyfunctional compound to form a crosslinking structure.

11. The optical element according to claim 1, wherein the polyfunctional compound is represented by any one of the following Formulae (M-1) to (M-13):

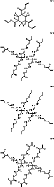

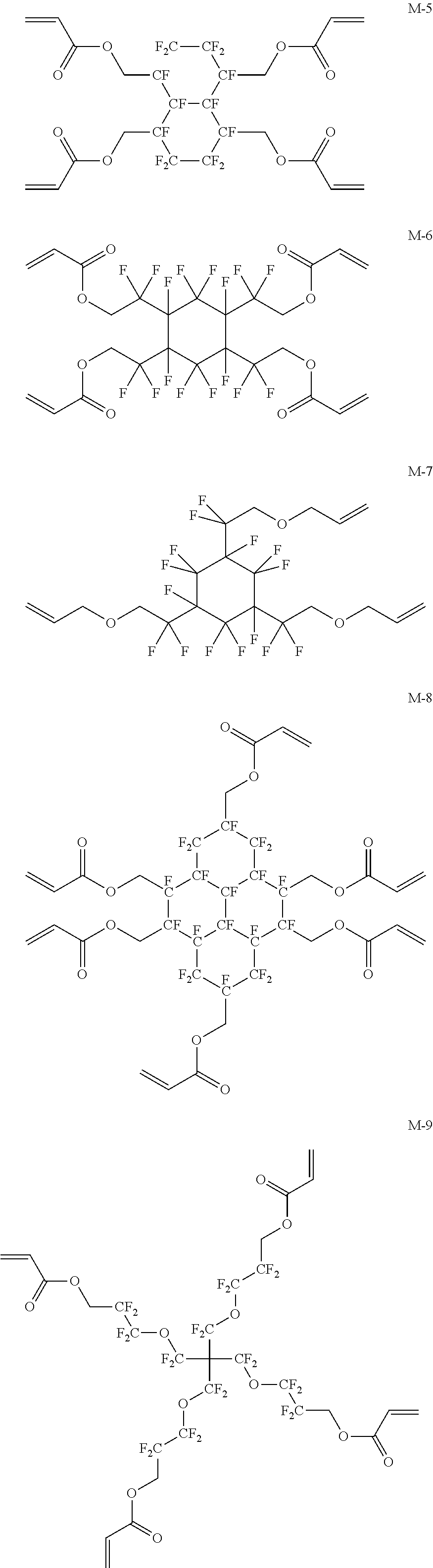

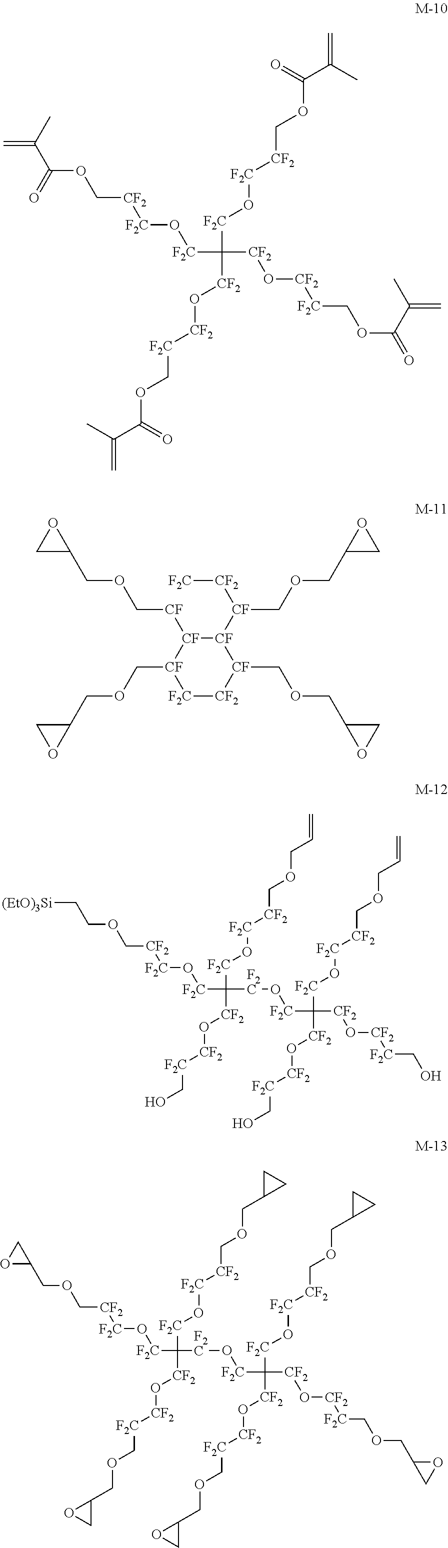

12. The optical element according to claim 1, wherein the first substrate comprises a conductive film, and the conductive surface of the first substrate is a surface of the conductive film.

13. The optical element according to claim 1, wherein at least one of the first substrate or the second substrate has light transmittance of 80% or higher over the entire wavelength region of from 380 nm to 770 nm.

14. The optical element according to claim 7, wherein the first substrate comprises a conductive film, the conductive surface of the first substrate is a surface of the conductive film, and at least one of the first substrate or the second substrate has light transmittance of 80% or higher over the entire wavelength region of from 380 nm to 770 nm.

15. The optical element according to claim 8, wherein the first substrate comprises a conductive film, the conductive surface of the first substrate is a surface of the conductive film, and at least one of the first substrate or the second substrate has light transmittance of 80% or higher over the entire wavelength region of from 380 nm to 770 nm.

16. The optical element according to claim 9, wherein the first substrate comprises a conductive film, the conductive surface of the first substrate is a surface of the conductive film, and at least one of the first substrate or the second substrate has light transmittance of 80% or higher over the entire wavelength region of from 380 nm to 770 nm.

17. The optical element according to claim 11, wherein the first substrate comprises a conductive film, the conductive surface of the first substrate is a surface of the conductive film, and at least one of the first substrate or the second substrate has light transmittance of 80% or higher over the entire wavelength region of from 380 nm to 770 nm.

18. The optical element according to claim 17, wherein a viscosity of the non-conductive oil is in a range of from 0.01 mPa·s to 8 mPa·s, and the conductive hydrophilic liquid comprises an aqueous solvent and an electrolyte in a concentration range of from 0.1 mol/L to 10 mol/L.

19. An image display device provided with a pixel comprising the optical element according to claim 1, wherein the non-conductive oil comprises a coloring material.

20. An image display device provided with a pixel comprising the optical element according to claim 17, wherein the non-conductive oil comprises a coloring material.
